(19) United States
(12) Patent Application Publication
(10) Pub. No.: US 2019/0236671 A1
(43) Pub. Date: Aug. 1, 2019

(54) System, Method, and Software for Facilitating Online Auction Funding College Savings Accounts With Direct Distribution of Sales Proceeds to the College Savings Account

(71) Applicant: Jutse, LLC, Marion, OH (US)

(72) Inventor: Lori A. Kaylor, Marion, OH (US)

(73) Assignee: Jutse, LLC, Marion, OH (US)

(21) Appl. No.: 14/684,085

(22) Filed: Apr. 10, 2015

Related U.S. Application Data
(60) Provisional application No. 61/978,835, filed on Apr. 12, 2014.

(51) Int. Cl. G06Q 30/06; G06Q 40/02; G06Q 30/08

(52) U.S. Cl. CPC G06Q 30/0619; G06Q 30/08; G06Q 40/02; G06Q 30/0643

(57) ABSTRACT

A system, method, and software for facilitating hosted online sale of goods and/or services includes the steps electronically presenting at least one good and/or service available for purchase online from a seller. The seller makes at least one designation of a tax-deferred and/or tax-exempt savings plan account to receive at least a portion of proceeds from the sale. When a buyer purchases the good or service online, separate purchase and transaction fees are received by the host from the buyer for purchasing the at least one good and/or service. The purchase and transaction fees are maintained in separate accounts by the host until the purchase fee is directly provided to the at least one savings plan account designated by the seller on behalf of the seller.

### CROSS-REFERENCE TO RELATED APPLICATIONS

This application claims priority benefit of U.S. patent application No. 61/978,835 filed Apr. 12, 2014, the disclosure of which is expressly incorporated herein in its entirety by reference.

### STATEMENT REGARDING FEDERALLY SPONSORED RESEARCH

Not Applicable

### PARTIES TO A JOINT RESEARCH AGREEMENT

Not Applicable

### REFERENCE TO APPENDIX

Not Applicable

### FIELD OF THE INVENTION

The field of the present invention relates generally to electronic commerce and, more particularly, to hosted online sites for sale of goods and services.

### BACKGROUND OF THE INVENTION

Online auctions have become a fixture of electronic commerce. Auctions offer buyers the possibility of finding specialized goods and services, antiques, used items, and other items that can be difficult to find in conventional stores or in other electronic commerce storefronts. Because prices are not always fixed, buyers can also obtain some items at significant discounts to retail list prices. Auctions often offer sellers the benefit of price competition among buyers, creating markets for goods and services for which it is normally difficult to set prices.

While participants in these online auctions can generate significant income by selling various goods and services, there are limited or no options for distribution of the payments resulting from the sales other than directly to the seller. Accordingly, there is a need in the art for improved systems and methods for hosted online commerce sites having additional options for distribution of sale proceeds such as, for example, the funding of tax-deferred and or tax exempt savings plan accounts.

### SUMMARY OF THE INVENTION

Disclosed are systems, methods, and software for facilitating hosted online sites for the sale of goods and/or services which address one or more issues of the related art. Disclosed is a computer implemented method for facilitating online sale of goods and/or services. The disclosed method comprises the steps of, in combination, electronically presenting at least one good and/or service available for purchase from a seller, electronically receiving at least one designation from the seller of a savings plan account to receive at least a portion of proceeds from sale of the at least one good and/or service available for purchase from the seller, electronically receiving a purchase fee from a buyer for purchasing the at least one good and/or service available for purchase from a seller, electronically receiving a transaction fee, separate from the purchase fee, from the buyer for purchasing the good and/or service available for purchase from a seller, and directly providing the purchase fee to the at least one savings plan account on behalf of the seller.

Also disclosed is a system for online sale of goods and/or services wherein the system comprises, in combination, at least one central computer having memory, a processor in communication with the memory, and a network interface in communication with the processor for communicating with electronic devices. The memory comprises computer-executable instructions executable by the processor to perform the following steps: electronically presenting at least one good and/or service available for purchase from a seller; electronically receiving at least one designation from the seller of a savings plan account to receive at least a portion of proceeds from sale of the at least one good and/or service available for purchase from the seller; electronically receiving a purchase fee from a buyer for purchasing the at least one good and/or service available for purchase from a seller; electronically receiving a transaction fee, separate from the purchase fee, from the buyer for purchasing the good and/or service available for purchase from a seller; and directly providing the purchase fee to the savings plan account on behalf of the seller.

Also disclosed is one or more computer-readable media storing instructions for facilitating online sale of goods and/or services comprising computer-executable instructions that responsive to execution cause operations to be performed. The operations comprise, in combination, electronically presenting at least one good and/or service available for purchase from a seller, electronically receiving at least one designation from the seller of a savings plan account to receive at least a portion of proceeds from sale of the at least one good and/or service available for purchase from the seller, electronically receiving a purchase fee from a buyer for purchasing the at least one good and/or service available for purchase from a seller, electronically receiving a transaction fee, separate from the purchase fee, from the buyer for purchasing the good and/or service available for purchase from a seller, and directly providing the purchase fee to the savings plan account on behalf of the seller.

From the foregoing disclosure and the following more detailed description of various preferred embodiments it will be apparent to those skilled in the art that the present invention provides a significant advance in the technology and art of hosted online sites for the sale of goods and/or services. Particularly significant in this regard is the potential the invention affords for providing an easy to use method for accruing college savings. Additional features and advantages of various preferred embodiments will be better understood in view of the detailed description provided below.

### BRIEF DESCRIPTION OF THE DRAWINGS

These and further features of the present invention will be apparent with reference to the following description and drawing, wherein:

FIG. 1 is a schematic diagram showing a system for an online auction having distribution of sale proceeds to a college savings plan according to the present invention.

FIG. 1A is schematic view of an exemplary server or computer of an auction host of the system of FIG. 1.

FIG. 1B is schematic view of an exemplary computer of a seller of the system of FIG. 1.

FIG. 1C is schematic view of an exemplary computer of a buyer of the system of FIG. 1.

FIG. 1D is schematic view of an exemplary server or computer of a savings plan provider of the system of FIG. 1.

FIG. 1E is schematic view of an exemplary server or computer of an online payment system of the system of FIG. 1.

FIG. 2 is flow diagram showing certain steps of an online auction accomplished by the system of FIG. 1.

FIG. 3 is an exemplary screen display for a home page of the system of FIG. 1.

FIG. 4 is an exemplary screen display for an introduction page of the system of FIG. 1.

FIG. 5 is an exemplary screen display for a benefits page of the system of FIG. 1.

FIG. 6 is an exemplary screen display for a 529 college savings page of the system of FIG. 1.

FIG. 7 is an exemplary screen display for a sell page of the system of FIG. 1.

FIG. 8 is an exemplary screen display for a buy page of the system of FIG. 1.

FIG. 9 is an exemplary screen display for a save page of the system of FIG. 1.

FIG. 10 is an exemplary screen display for a FAQ's page of the system of FIG. 1.

FIG. 11 is an exemplary screen display for a website FAQ's page of the system of FIG. 1.

FIG. 12 is an exemplary screen display for a sell portal of the system of FIG. 1.

FIG. 13 is an exemplary screen display for a registration page of the system of FIG. 1.

FIG. 14 is an exemplary screen display for the registration page of FIG. 13 but wherein the page is scrolled down.

FIG. 15 is another view of the registration page to FIGS. 13 and 14 but wherein the page is further scrolled down.

FIG. 16 is another view of the registration page similar to FIG. 15 wherein option 1 has been selected.

FIG. 17 is another view of the registration page similar to FIG. 15 wherein option 2 has been selected.

FIG. 18 is another view of the registration page similar to FIG. 15 wherein option 3 has been selected.

FIG. 19 is another view of the registration page similar to FIG. 15 wherein option 4 has been selected.

FIG. 20 is an exemplary screen display for a “my dashboard” page of the system of FIG. 1.

FIG. 21 is an exemplary screen display for a manage bidding page of the system of FIG. 1.

FIG. 22 is an exemplary screen display for an auction page of the system of FIG. 1.

FIG. 23 is an exemplary screen display for a marketplace page of the system of FIG. 1.

FIG. 24 is an exemplary screen display for a product detail page of the system of FIG. 1.

FIG. 25 is an exemplary screen display for a login page of the system of FIG. 1.

FIG. 26 is an exemplary screen display for a sign-up email of the system of FIG. 1.

It should be understood that the appended drawings are not necessarily to scale, presenting a somewhat simplified representation of various preferred features illustrative of the basic principles of the invention. The specific design features of the systems and methods as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the systems illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved systems and methods for facilitating hosted online commerce sites for the sale of goods and/or services disclosed herein. The following detailed discussion of various alternative and preferred embodiments will illustrate the general principles of the invention with respect to saving for a college education utilizing a 529 college savings plan account. However, other embodiments will be apparent to those skilled in the art given the benefit of this disclosure such as, for example, funding any type of tax-deferred and/or tax exempt savings plan account including, but not limited to, education savings plans, retirement savings plans (IRAs, 401Ks, RRSPs, and the like), investment savings plans (ISAs, JISAs, tax-exempt money markets, and the like), and the like.

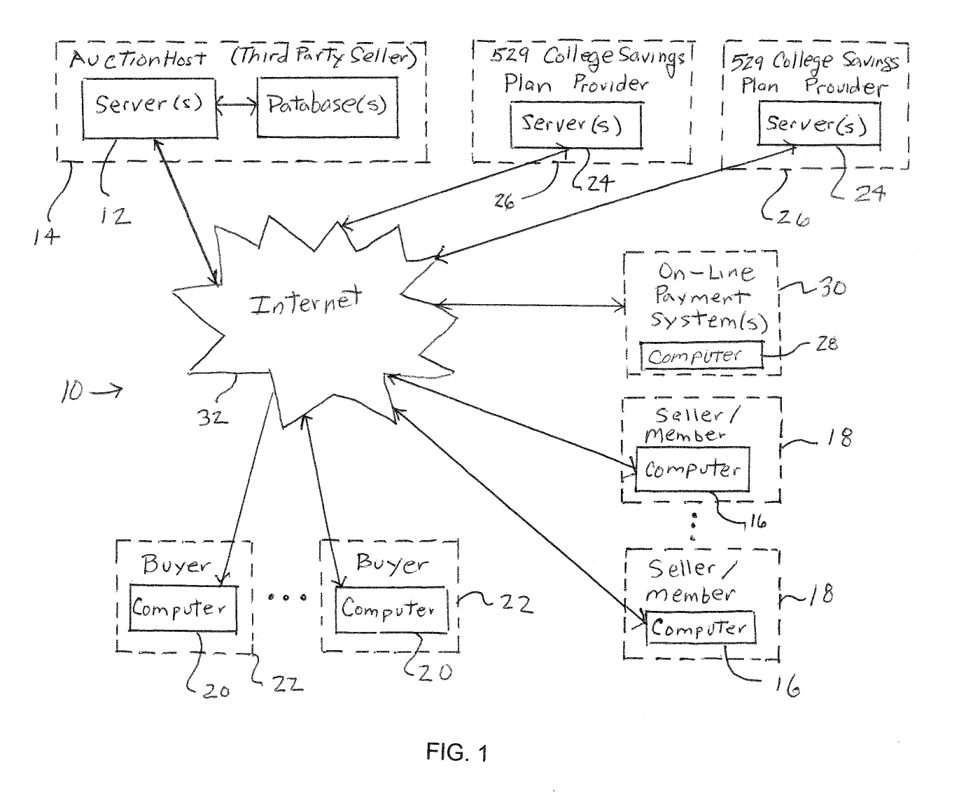

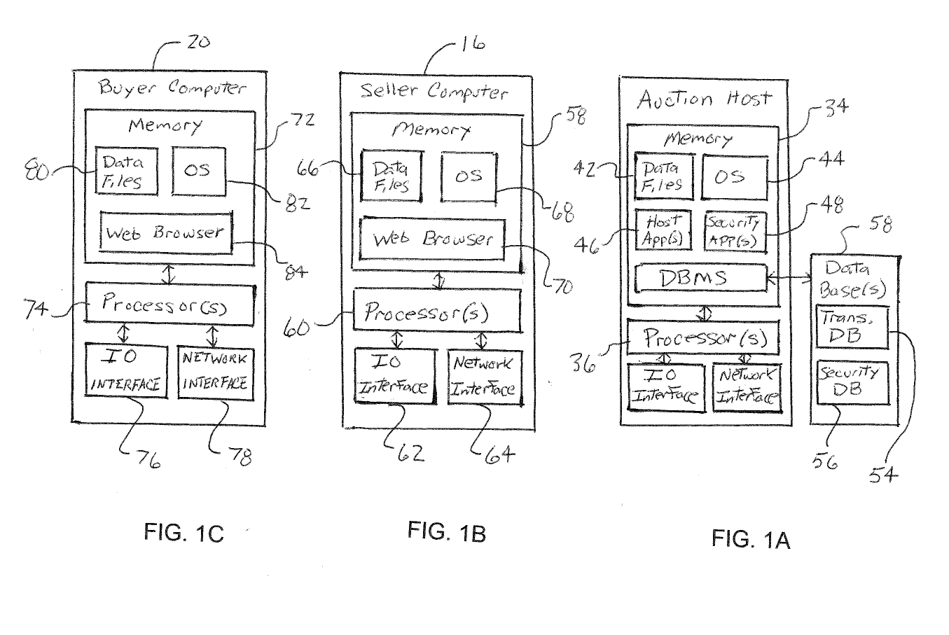

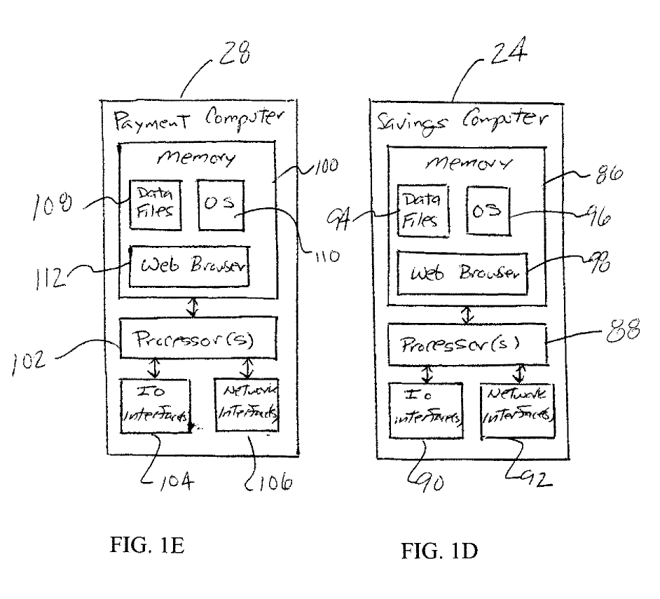

Referring now to the drawings, FIG. 1 illustrates an exemplary system 10 for facilitating hosted online commerce, that is hosted online sale of goods and/or services, according to the present invention. Sellers present items to be sold to buyers on an online auction site administered by an auction host or third party seller. Buyers view and bid on and/or purchase the items presented online on behalf of the sellers according to the rules of the auction host, typically resulting in the highest bid winning the auction at the close of a predetermined time period. Such online auctions are well known, including those where the auction host is eBay, Yahoo.com, Ubid.com, Amazon.com, and many others. It is noted, however, that the auction host can have any other suitable rules.

It should be noted that the term “auction” is used in this specification and claims to describe a forward auction where a seller offers goods online via a bidding process in which buyers offer increasingly higher purchase prices to sellers for goods or services until a predetermined event occurs such as, for example, a time deadline or a maximum purchase price is reached. However, it should be understood that where context permits, the term “auction” is used in this specification and claims to further encompass other methods by which a seller offers goods or services for sale such as, for example, a reverse auction where sellers offer decreasingly lower purchase process to sellers, a direct online product offering where sellers offer fixed selling prices to buyers for goods and services, or any combination thereof. Thus, the term auction should not be understood to be limiting except where context requires it.

The illustrated system 10 includes at least one server or computer 12 located at the auction host or service provider 14, at least one computer 16 of a seller 18, at least one computer 20 of a buyer 22, at least one server or computer 24 located at a college savings plan provider 26, and at least one server or computer 28 at an on-line payment system 30. The term “server” is used in this specification and claims to mean a computer configured to manage, store, send and process data 24-hours a day. The term “computer” is used in the specification and claims to mean any electronic device that can suitably communicate via a computer network including, but not limited to, desktop computers, laptop computers, portable electronic devices or mobile devices, digital cameras, video game systems, messaging systems, video players, smart televisions, and the like. The terms “portable electronic device” and “mobile device” are used in the specification and claims to mean a handheld electronic device that utilizes rechargeable batteries as a power source and that that can suitably communicate with event system server via the computer network including, but not limited to, smart phones, personal digital assistants (PDAs), mp3 or other music players, video game players, messaging systems, tablet computers, notebook computers, and the like.

The illustrated auction host server 12, the illustrated seller computers 16, the illustrated buyer computers 20, the illustrated savings plan servers 24, and the illustrated payment system servers 24 are in electronic communication with one another via a communication system 32. The illustrated communication system 32 is a computer network such as the Internet but any other suitable communication system can alternatively be utilized such as, for example, an intranet, any other type network of computers, and the like.

The illustrated auction host or service provider server or computer 12 includes memory 34, at least one processor or central processing units (CPU) 36 in communication with the memory 34, one or more input/output (IO) interfaces 38 in communication with the processor 36, and at least one network interface 40 in communication with the processor 36, all of which is configured to carry out the functions and steps described herein (see FIG. 1A), The illustrated memory 34 stores data files 42, an operating system (OS) 44, host applications 46 for communications with web browsers and mobile applications, security applications 48 for limiting access to authorized users, and a database management system 50 for interfacing with databases 52 having stored information. It is noted that any other suitable information and/or software can be stored in the processor and/or the memory. The illustrated databases 52 are separate from the service provider server or computer 12 but it is noted that the databases 52 can alternatively be integrated with the service provider server or computer 12. The illustrated databases 52 are located at the service provider 14 and/or a cloud location but it is noted that the databases 52 can alternatively be located at any other suitable location and/or be of any other suitable type. The illustrated databases 52 include a transaction database 54 and a security database 56 but any other suitable types of databases can alternatively or additionally be utilized. The at least one processor 36 can be of any suitable type. The at least one IO interface 38 can be of any suitable type such as, for example, a keyboard, a mouse, a track ball, a touch pad, a camera, a speaker, a monitor, a printer, a modem, a disk drive and the like. The network interface 40 can be of any suitable type such as, for example, a network interface card, software simulating a network card, and the like. The illustrated processor and memory 36, 40 are programmed with computer software for facilitating an online auction of goods and/or services including providing a web portal for interfacing with the seller computers and the buyer computers as described in more detail hereinafter.

The illustrated auction host server or computer 12 is located at the physical location of the auction host 14 and can be remotely accessed by both the sellers 18 and the buyers 22 via the communication system 32. It is noted, however, that the auction host server 12 is not required to be physically located at physical facilities of the auction host 14. It is also noted that the system 10 can be cloud based.

The illustrated seller computer 16 includes memory 58, at least one processor or central processing units (CPU) 60 in communication with the memory 58, one or more input/output (IO) 62 interfaces in communication with the processor 60, and at least one network interface 64 in communication with the processor, all of which is configured to carry out the functions and steps described herein (see FIG. 1B). The illustrated memory 58 stores data files 66, an operating system (OS) 68, and a web browser 70. It is noted that any other suitable information and/or software can be stored in the processor and/or memory 60, 58. The at least one processor 60 can be of any suitable type. The at least one IO interface 62 can be of any suitable type such as, for example, a keyboard, a mouse, a track ball, a touch pad, a camera, a speaker, a monitor, a printer, a modern, a disk drive and the like. The network interface 64 can be of any suitable type such as, for example, a network interface card, software simulating a network card, and the like. The illustrated processor and memory 60, 58 are programmed with the web browser for communicating with the web portal of the auction host server 12 as described in more detail hereinafter.

The illustrated seller computer 16 is located at the physical location of the seller 18 such as, for example, a home, a place of business, and the like but it is noted that the seller computer 16 can be located at any other location. It is noted that the seller computer 16 can be a desktop computer or a mobile computer or device. It is further noted that that while the illustrated system 10 shows two seller computers 16, it should be appreciated that there is typically a larger number of seller computers 16 located at a large number of associated locations.

The illustrated buyer computer 20 includes memory 72, at least one processor or central processing units (CPU) 74 in communication with the memory, one or more input/output (IO) interfaces 76 in communication with the processor, and at least one network interface 78 in communication with the processor 74, all of which is configured to carry out the functions and steps described herein (see FIG. 1B). The illustrated memory 72 stores data files 80, an operating system (OS) 82, and a web browser 84. It is noted that any other suitable information and/or software can be stored in the processor and/or memory. The at least one processor 74 can be of any suitable type. The at least one IO interface 76 can be of any suitable type such as, for example, a keyboard, a mouse, a track ball, a touch pad, a camera, a speaker, a monitor, a printer, a modem, a disk drive and the like. The network interface 78 can be of any suitable type such as, for example, a network interface card, software simulating a network card, and the like. The illustrated processor and memory 74, 72 are programmed with the web browser for communicating with the web portal of the auction host server 12 as described in more detail hereinafter.

The illustrated buyer computer 20 is located at the physical location of the seller 22 such as, for example, a home, a place of business, and the like but it is noted that the buyer computer can be located at any other location. It is noted that the buyer computer 20 can be a desktop computer or a mobile computer or device. It is further noted that that while the illustrated system 10 shows two buyer computers 20, it should be appreciated that there is typically a larger number of buyer computers 20 located at a large number of associated locations.

The illustrated savings plan provider server or computer 24 includes memory 86, at least one processor or central processing units (CPU) 88 in communication with the memory 86, one or more input/output (TO) interfaces 90 in communication with the processor, and at least one network interface 92 in communication with the processor, all of which is configured to carry out the functions and steps described herein (see FIG. 1B). The illustrated memory 86 stores data files 94, an operating system (OS) 96, and a web browser 98. It is noted that any other suitable information and/or software can be stored in the processor and/or memory 88, 86. The at least one processor 88 can be of any suitable type. The at least one IO interface 90 can be of any suitable type such as a keyboard, a mouse, a track ball, a touch pad, a camera, a speaker, a monitor, a printer, a modem, a disk drive and the like. The network interface 92 can be of any suitable type such as, for example, a network interface card, software simulating a network card, and the like. The illustrated processor and memory 88, 86 are programmed with the web browser for communicating with the server 12 of the auction host 14 as described in more detail hereinafter.

The illustrated savings plan provider server 24 is located at the physical location of the savings plan provider 26 but it is noted that the savings plan provider server 24 can be located at any other suitable location. It is noted that the savings plan provider server 24 can be a desktop computer or any other suitable device. It is further noted that that while the illustrated system 10 shows two savings plan provider server, it should be appreciated that there is typically a larger number of savings plan provider servers 26 located at a large number of associated locations. Ideally, there is at least one savings plan provider 26 associated with each of the fifty states.

The illustrated payment system server or computer 28 includes memory 100, at least one processor or central processing units (CPU) 102 in communication with the memory 100, one or more input/output (JO) interfaces 104 in communication with the processor 102, and at least one network interface 106 in communication with the processor 102, all of which is configured to carry out the functions and steps described herein (see FIG. 1B). The illustrated memory 100 stores data files 108, an operating system (OS) 110, and a web browser 112. It is noted that any other suitable information and/or software can be stored in the processor and/or memory 102, 100. The at least one processor 102 can be of any suitable type. The at least one IO interface 104 can be of any suitable type such as, for example, a keyboard, a mouse, a track ball, a touch pad, a camera, a speaker, a monitor, a printer, a modem, a disk drive and the like. The network interface 106 can be of any suitable type such as, for example, a network interface card, software simulating a network card, and the like. The illustrated processor and memory 102, 100 are programmed with the web browser for communicating with the server 12 of the auction host 14 as described in more detail hereinafter.

The illustrated payment system server 28 is located at the physical location of the online payment system 30 but it is noted that the payment system server 28 can be located at any other suitable location. It is noted that the payment system server 28 can be a desktop computer or any other suitable device. It is further noted that that while the illustrated system 10 shows one payment system server 28, it should be appreciated that there is typically a plurality of online payment systems.

The illustrated system software or web platform resides at the auction host server and is accessible to the sellers via a web portal and/or a mobile dashboard and to the buyers via the web portal and/or mobile application dashboard.

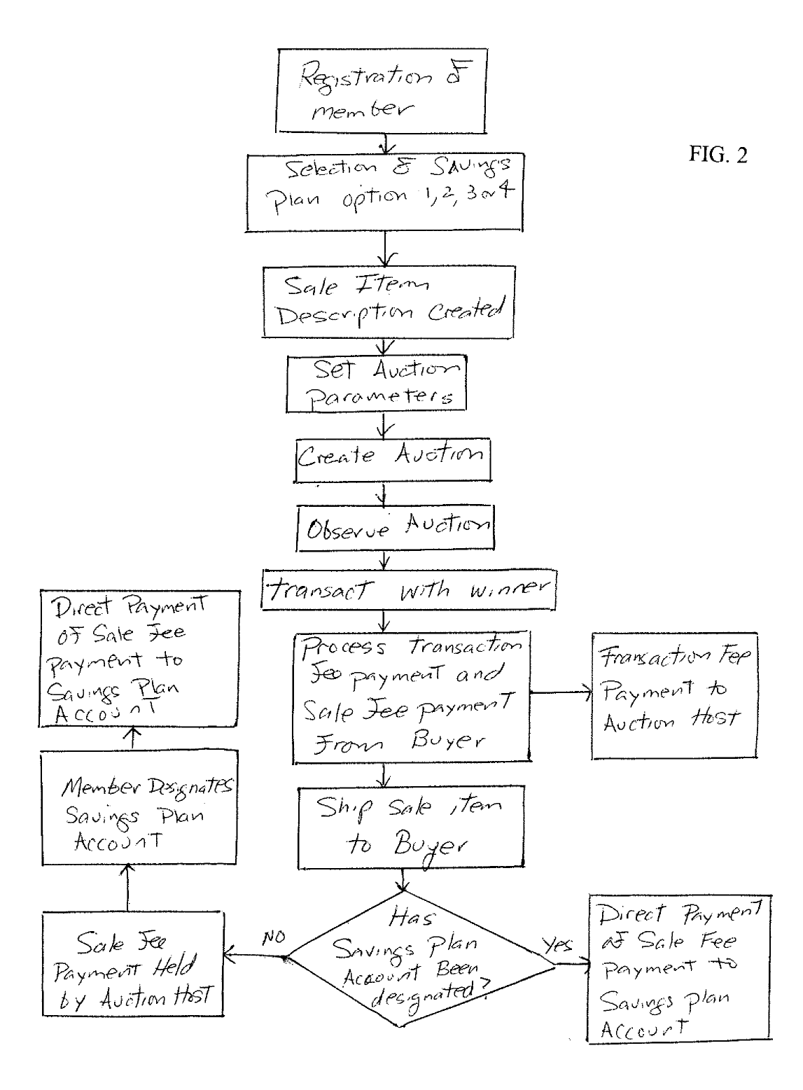

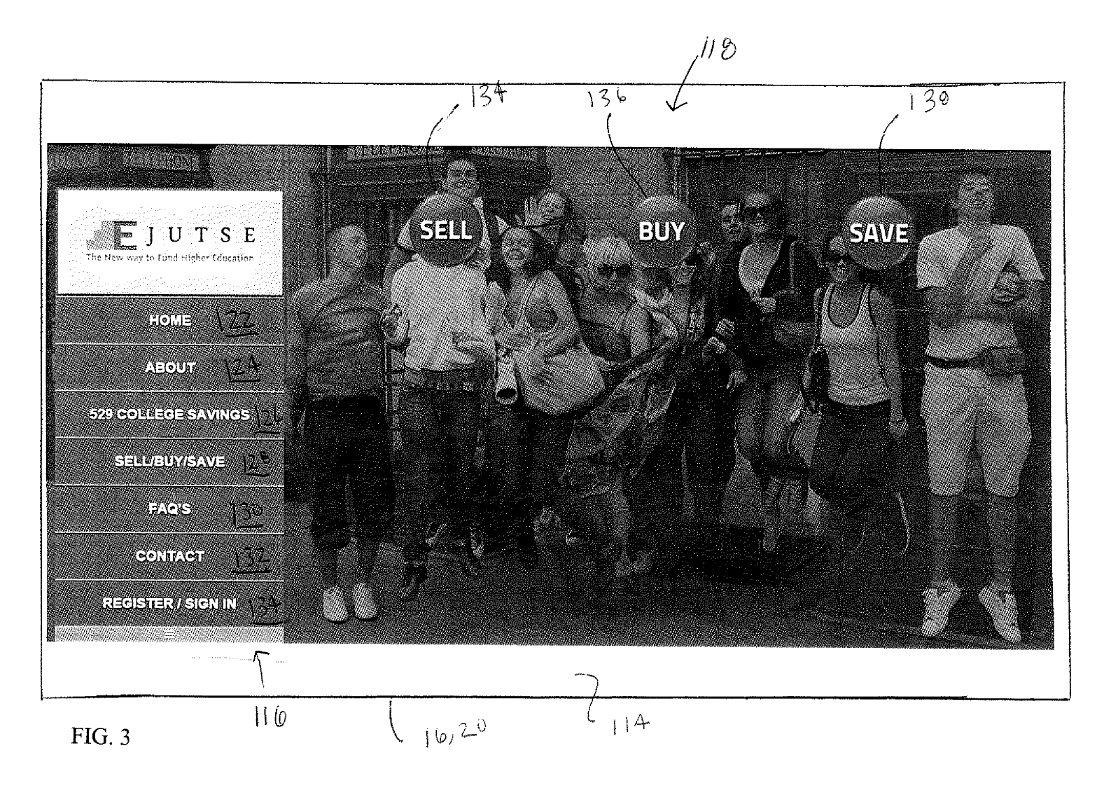

FIG. 2 illustrates exemplary steps for a method for facilitating auction-based online commerce according to the present invention. First, a seller identifies an item that the seller wishes to sell on the online auction. If they are not a registered member of the auction site, they then register as a member as described in more detail below. As part of the registration process, the user selects on of a plurality of options for designating a saving plan account for receiving at least a portion of sale proceeds as described below. Next, the seller creates a description of the item to be auctioned, which typically includes a combination of words and photographs that depict the details of the item. Additionally, the seller can upload a video which can include a person talking about the item for sale and/or the beneficiary saving for college. The seller then sets various auction parameters, such as the dates of the auction, the minimum price the seller will accept for the item, as well as other factors such as whether the seller is willing to pay shipping costs, to ship outside a given region, and the like. These parameters are typically entered via a conventional computer data entry mechanism, such as a web-based form, such as one created in HTML or a similar markup language like dynamic HTML or the like. The form can contain the relevant data fields for setting auction parameters and when submitted by the seller to the auction host through an online submission mechanism, the servers of the auction host recognize the form and facilitate creation of the auction. Such steps are conventional in online auctions and are typically created by CGI scripts or similar coding mechanisms for recognizing HTTP messages and executing appropriate actions.

Once the seller has created the auction, potential buyers can view the item for sale online at the site hosted by the auction host. The seller, the auction host, and others can observe the auction until it terminates, either with one or more winning buyers who have at least met the seller's minimum price for the item, or with no winner. Once one or more winners have been determined, the seller and/or the auction host interact with the winning buyer to complete the transaction. This interaction can include communication between seller and/or the auction host and the buyer, such as an exchange of emails, a telephone call, and the like. The transaction step may include various sub-steps, such as the seller and/or auction host communicating shipping options to the buyer, the buyer sending address information to the seller and/or auction host, and the buyer making payment to the auction host. The buyer then pays for the item by paying a transaction fee and a sale or purchase fee.

The buyer can make payment by any suitable electronic means such as, for example, PayPal, Visa, MasterCard, and the like. The sale or purchase fee is typically the sale proceeds or sale price less the transaction fee but alternatively the sale or purchase fee can be the entire sale proceeds or sale price and the buyer or seller must separately pay the transaction fee in addition to the purchase price. Thus, payment processing generates two separate transactions from the buyer to the auction host. The seller then ships the item to the buyer (or directs shipment to the buyer from a third party). The shipping step may involve an additional charge for the buyer, the seller, or both. The transaction fee is retained by the auction host as payment for hosting the auction and placed, for example, in its operating account. If the seller has designated a savings plan account, the sale or purchase fee is initially deposited into a trust or other account separate from the operating account where the transaction fee is deposited so that the fees are not co-mingled. After a predetermined period of time, such as, for example, 21 days, the sale or purchase fee is directly sent by the auction host to the designated savings plan account. The predetermined period of time enables the auction host to receive any complaints or problems from the buyer that may require a return of all or a portion of the sale or purchase fee. If the seller has not designated a savings plan account, the sale or purchase fee is initially deposited into the trust or other separate account by the auction host until the latter of the predetermined period of time and the time as the seller designates a savings plan account for the sale fee, and then is directly sent by the auction host to the designated savings plan account. In the illustrated embodiment, each participating college savings plan provider administrator (typically one per state) receives a roster with its required information at a predetermined period of time such as, for example, once a month. The roster includes at least the account holder name, the account number, the beneficiary name, and the amount of the deposit. The required information for the roster is plan/state specific so there is variation between the various rosters provided to the plans/states. For example, if the State of Colorado had 100 persons select and setup the Stable Value Plan, its designated person receives a roster with the 100 account holder names, account numbers, beneficiary names, and associated deposit amounts. The auction host makes a deposit to the savings plan administrator that is a cumulative amount for all accounts of the particular savings plans for the predetermined time period. For example, if the 100 persons on the roster are to receive $20 each for their account, the savings plan administrator will receive a single ACH transfer of $2000 simultaneously with the roster which provides the allocation of the funds among the 100 accounts.

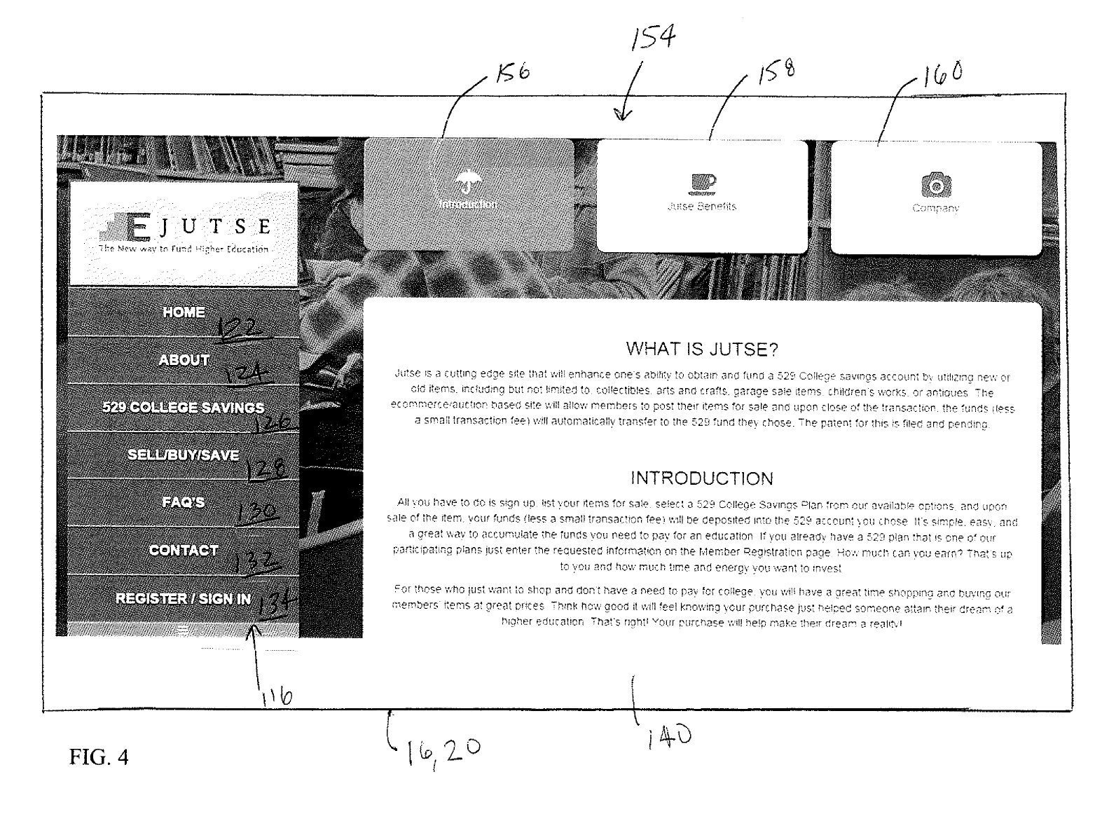

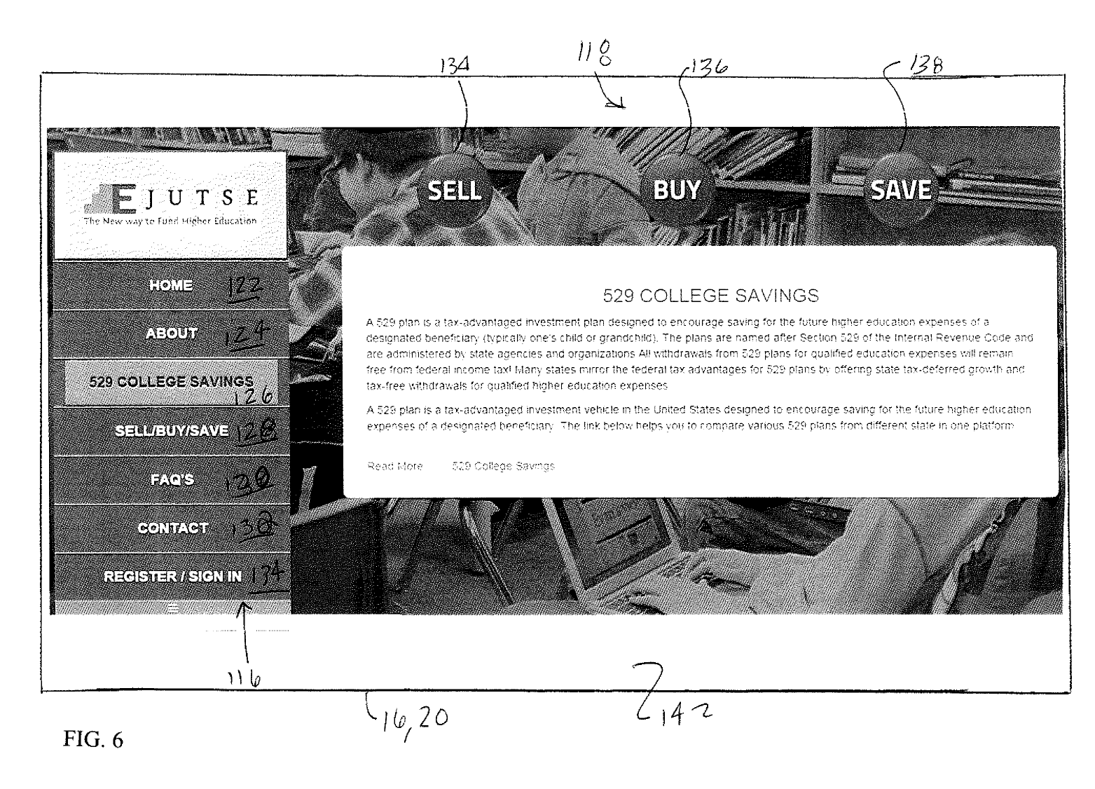

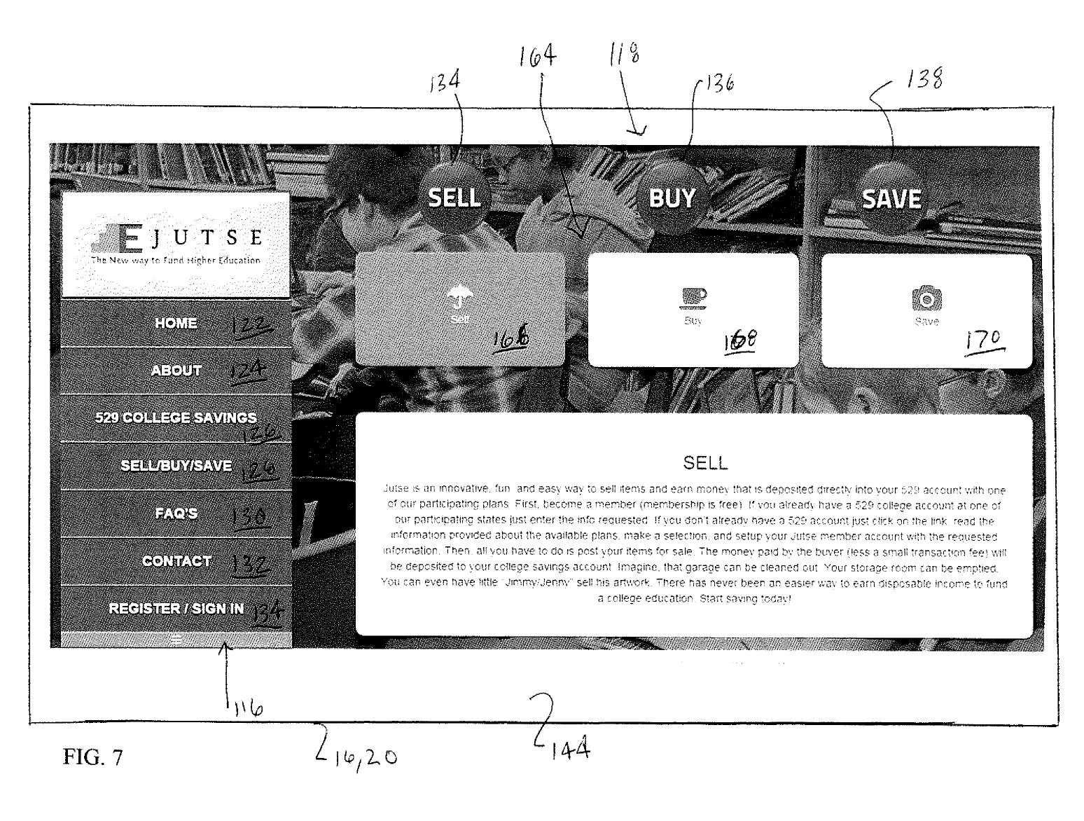

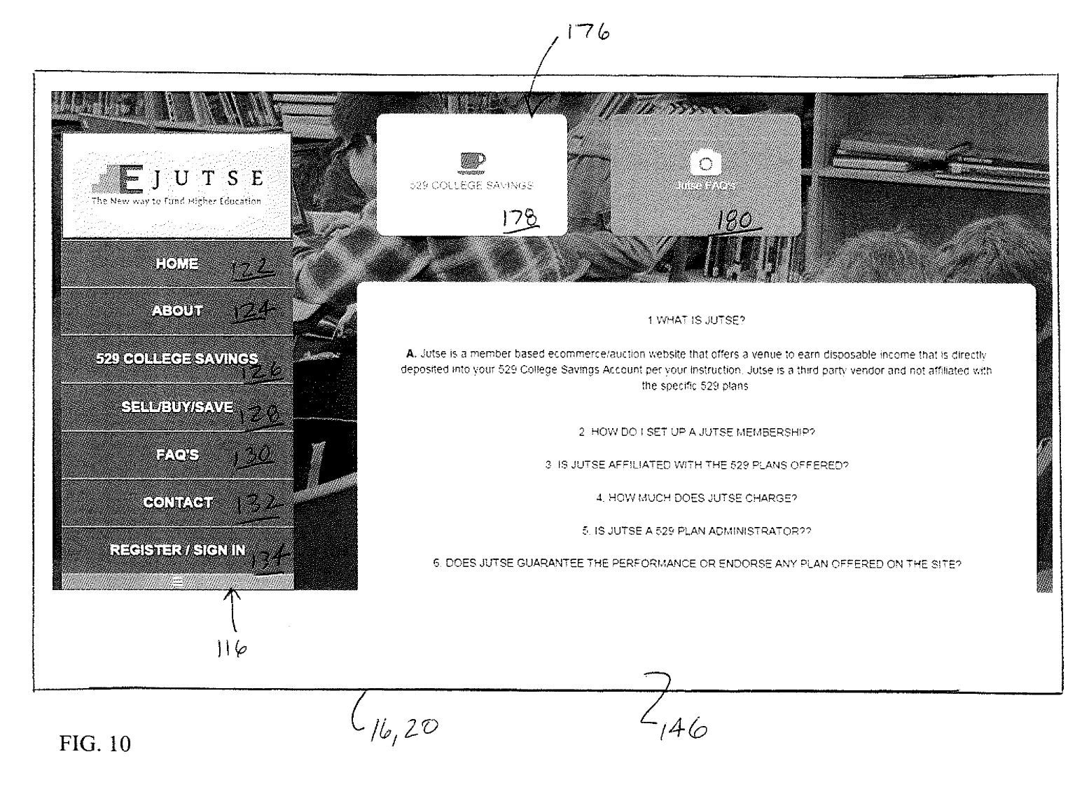

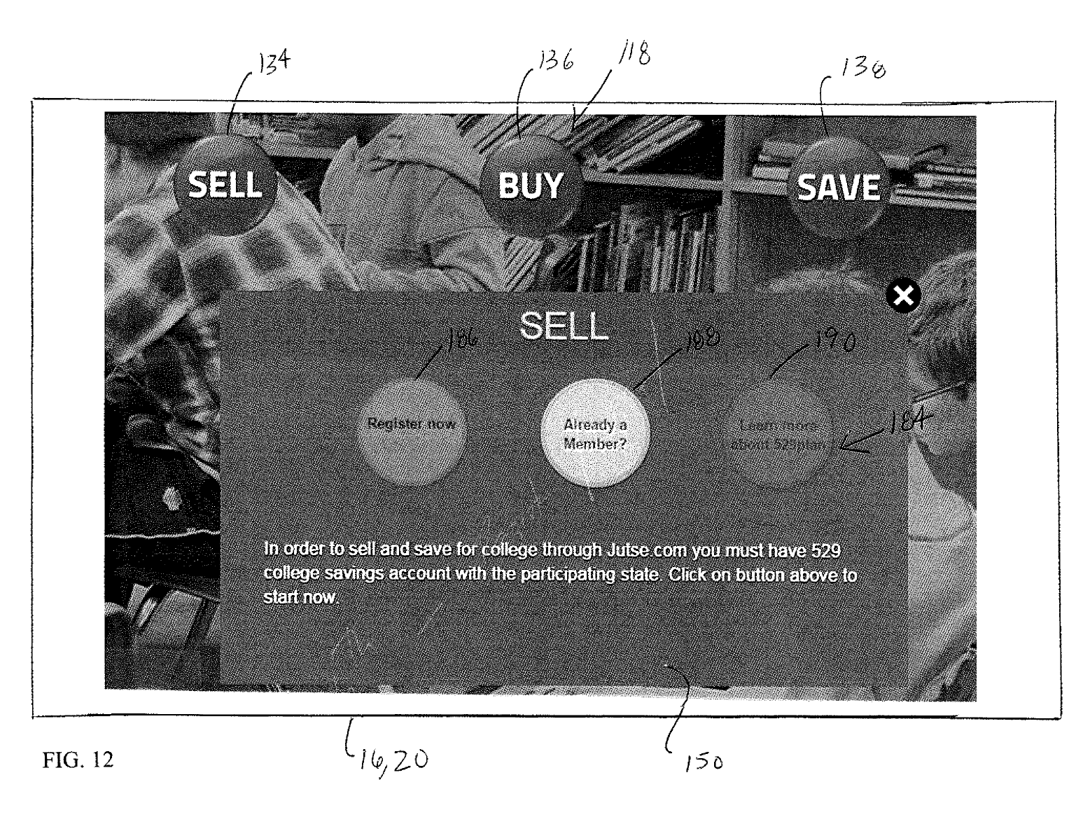

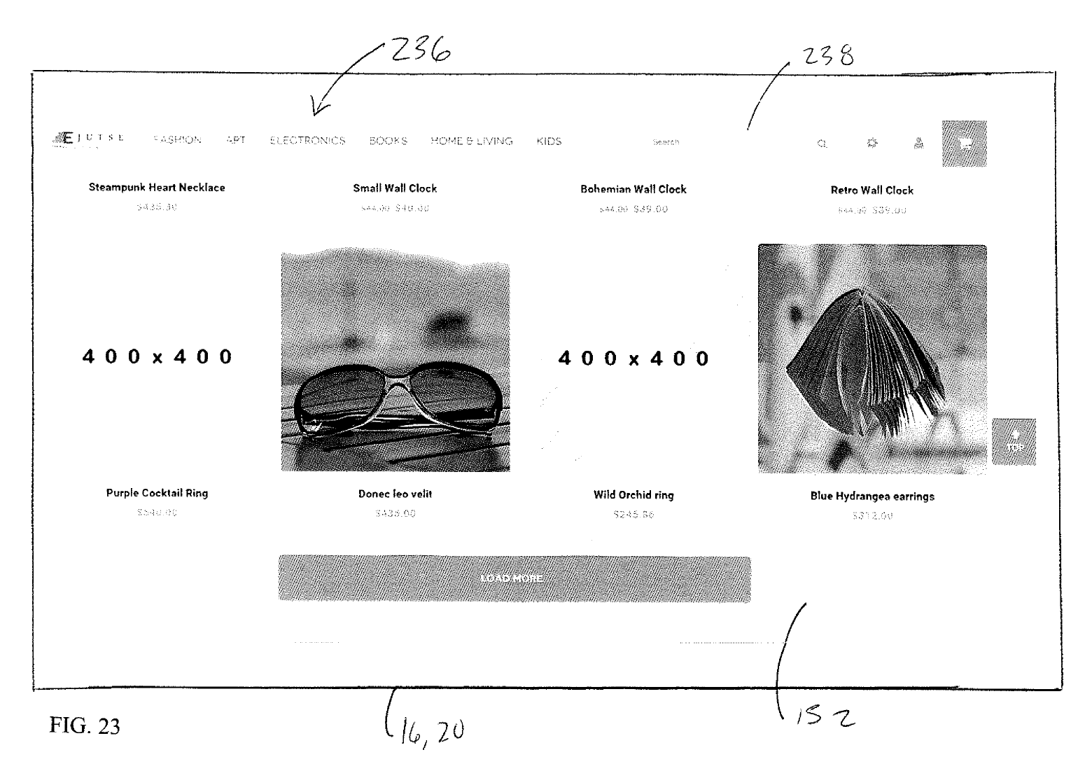

FIG. 3 illustrates a user's computer 16, 20 displaying an exemplary application dashboard or home page 114. The illustrated home page 114 displays a first plurality of links or buttons (“HOME”, “ABOUT”, “529 COLLEGE SAVINGS”, “SELL/BUY/SAVE”, “FAQ'S”, “CONTACT”, and “REGISTER/SIGN IN”) 116 and a second plurality of links or buttons (“SELL”, “BUY” and “SAVE”) 118 that when selected by the user will take the user to other pages. FOR the first plurality of links 116, the illustrated first or “HOME” link 120 takes the user to the home page 114 of the web platform (See FIG. 3). The illustrated second or “ABOUT” link 122 takes the user to the about page 140 of the web platform (See FIG. 4). The illustrated third or “529 COLLEGE SAVINGS” link 124 takes the user to a 529 College savings page 142 of the web platform (See FIG. 6). The illustrated fourth or “SELL/BUY/SAVE” link 126 takes the user to a sell/buy/save page 144 of the web platform (See FIG. 7). The illustrated fifth or “FAQ'S” link 128 takes the user to a frequently asked questions page 146 of the web platform (See FIG. 10). The illustrated sixth or “CONTACT” link 130 takes the user to a contacts page 148 of the web platform. The illustrated seventh or “REGISTER/SIGN IN” link 132 takes the user to a sell page or window 150 of the web platform (see FIG. 12). In the illustrated embodiment, the first plurality of links 116 is displayed in a column at the left side of the screen. Alternatively, the first plurality of links 116 can be located at any other suitable location. It is noted that the first plurality of links 116 can alternatively have any other suitable quantity and/or type of links. For the second plurality of links 118, the illustrated first or “SELL” link 134 takes the user to the sell page 150 of the web platform (See FIG. 12). The illustrated second or “BUY” link 136 takes the user to a marketplace page 152 of the web platform (See FIG. 23). The illustrated third or “SAVE” link 138 takes the user to a page of separate website (not shown) providing information comparing 529 savings plans by state and other information such as, for example, www.collegesavings.org/planComparisonState.aspx. In the illustrated embodiment, the second plurality of links 118 is displayed in a row at the top of the screen. Alternatively, the second plurality of links 118 can be located at any other suitable location. It is noted that the second plurality of links 118 can alternatively have any other suitable quantity and/or type of links. It is also noted that the home page 114 can alternatively have any other suitable form and/or information.

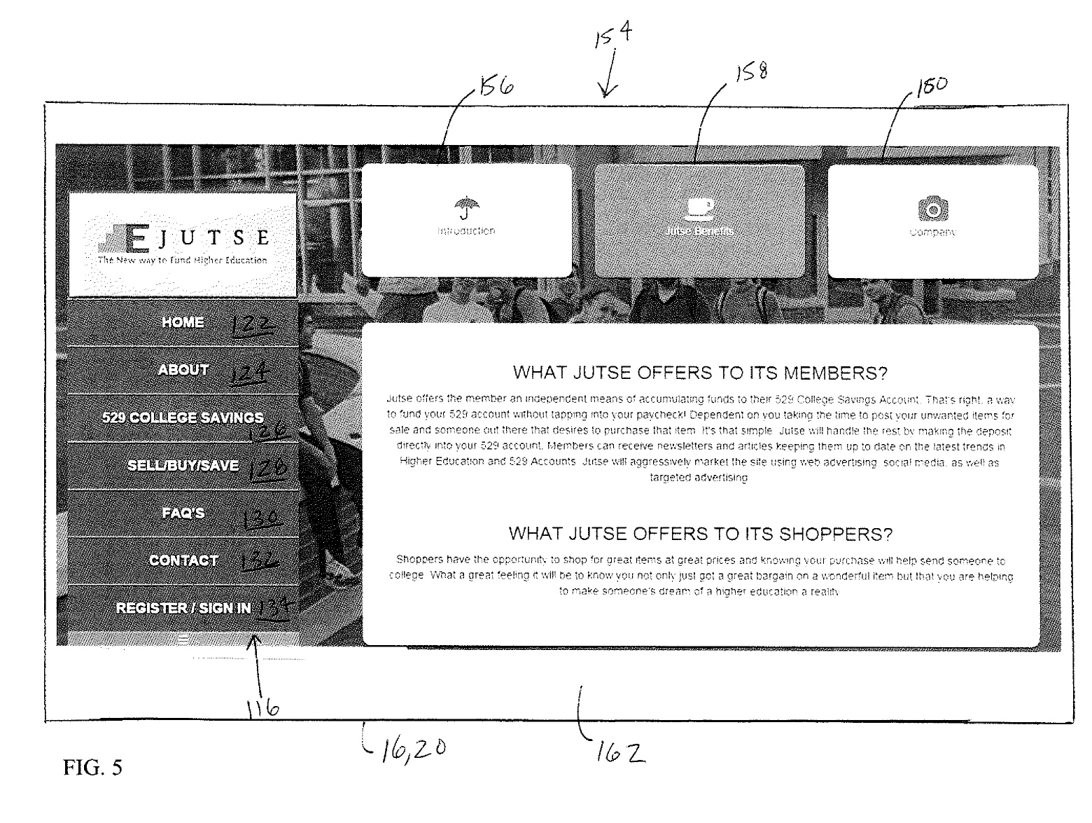

FIG. 4 illustrates a user's computer displaying an exemplary about page 140 which is reached by activating the above-described “ABOUT” link 122. The illustrated about page 140 has the first plurality of links 166 and also has a third plurality of links or tabs (“Introduction”, “Benefits”, and “Company”) that when selected by the user will take the user to other pages. The illustrated “Introduction” link 156 takes the user to the about page 140 (see FIG. 4) as described in this paragraph so that the user has an additional way to the about page 140. The illustrated “Benefits” link 158 takes the user to the benefits page 162 (see FIG. 5) as described below. The illustrated “Company” link 160 takes the user to a company page (not shown) displaying information about the auction host. In the illustrated embodiment, the third plurality of links 154 is displayed in a row at the top of the screen. Alternatively, the third plurality of links 154 can be located at any other suitable location. It is noted that the third plurality of links 154 can alternatively have any other suitable quantity and/or type of links. The illustrated about page 140 also displays introductory information including a section providing introductory information about what the website is and a section providing introductory information about how the website works. It is also noted that the about page 140 can alternatively have any other suitable form and/or information.

FIG. 5 illustrates a user's computer 16, 20 displaying an exemplary website benefits page 162 which is reached by activating the above described “Benefits” link 158. The illustrated benefits page 162 has the first plurality of links 116 and also has the third plurality of links 154. The illustrated benefits page 162 also displays introductory information including a section providing introductory information about what the website provides to its members and a section providing introductory information about what the website offers to shoppers or buyers. It is also noted that the benefits page 162 can alternatively have any other suitable form and/or information.

FIG. 6 illustrates a user's computer 16, 20 displaying an exemplary 529 college savings page 142 which is reached by activating the above-described “529 COLLEGE SAVINGS” link 124. The illustrated 529 college savings page 142 has the first plurality of links 116 and also has the second plurality of link 118s. The illustrated 529 college savings page 142 also displays introductory information about 529 college savings plans. It is noted that the 529 college savings page 142 can alternatively have any other suitable form and/or information.

As described in more detail below, Sellers can designate a 529 college savings plan account to which all or a portion of the payment from a buyer for a good or service from the seller should be directed. The seller can designate the 529 college savings plan account, and the portion of payments to be distributed thereto, at a time of registration with the auction host 14 and/or at a later time as described in more detail below.

529 college savings plans are named after section 529 of the Internal Revenue Code 26 U.S.C. § 529. While most 529 college savings plans allow investors from out of state, there can be significant state tax advantages and other benefits, such as matching grant and scholarship opportunities, protection from creditors and exemption from state financial aid calculations for investors who invest in 529 plans in their state of residence. There are two types of 529 college savings plans: Prepaid Plans; and Savings Plans. It is noted that in this specification and claims, the terms “529 college savings plans” and “college savings plans” are used to include all types of 529 college savings plans.

Prepaid plans allow one to purchase tuition credits at today's rates to be used in the future. Therefore, performance is based upon tuition inflation. Prepaid plans may be administered by states or higher education institutions. Currently, 8 states provide a prepaid tuition plan that is accepting new applicants. Those states include Florida, Illinois, Maryland, Massachusetts, Michigan, Nevada, Texas, and Virginia.

Savings plans are different in that all growth is based upon market performance of the underlying investments, which typically consist of mutual funds. Most savings plans offer a variety of age-based asset allocation options where the underlying investments become more conservative as the beneficiary gets closer to college age. Savings plans may be administered by states only. Although states administer savings plans, record-keeping and administrative services for many savings plans are usually delegated to a mutual fund company or other financial services company. Virginia 529 College Savings Plan is by far the largest of the savings plans. As of October 2013, Virginia 529 was actively managing over $43 billion in total assets and had over 2.2 million active accounts.

With the Economic Growth and Tax Relief Reconciliation Act of 2001 (EGTRRA), 529 plans gained their current prominence and tax advantages. Qualified distributions from 529 plans for qualified higher education expenses are exempt from federal income tax. Legislation introduced in the U.S. House of Representatives in 2011 by Congresswoman Lynn Jenkins, (R-KS) and Congressman Ron Kind, (D-WI) that would include 529 plan contributions in the SAVERs tax credit, make permanent the inclusion of computers as a qualified expense, provide for four annual investment direction changes and provide employers with an incentive to contribute to the 529 plans of their employees.

There are many advantages to a 529 college savings plan. First, although contributions are not deductible from the donor's federal income tax liability, many states provide state income tax deductions for all or part of the contributions of the donor. Beyond the potential state income tax deduction possibilities, a prime benefit of the 529 college savings plan is that the principal grows tax-deferred and distributions for the beneficiary's college costs are exempt from tax. Second, the donor maintains control of the account. With few exceptions, the named beneficiary has no rights to the funds. Most plans even allow you to reclaim the funds for yourself any time you desire, no questions asked. However, if a “non-qualified” withdrawal is made, the earnings portion will be subject to income tax and an additional 10% penalty tax. Third, a 529 plan can provide a very easy hands-off way to save for college. Once one decides which 529 plan to use, one completes a simple enrollment form and makes a contribution (or signs up for automatic deposits). The ongoing investment of the account is handled by the plan, not by the donor. Plan assets are professionally managed either by the state treasurer's office or by an outside investment company hired as the program manager. The donor will not receive a Form 1099 to report taxable or nontaxable earnings until the year of the withdrawals. If an investment switch is desired, donors may change to a different option in a 529 savings program every year (program permitting) or the account may be rolled over to a different state's program provided no such rollover for the beneficiary has occurred in the prior 12 months. 529 plans generally have very low minimum start-up and contribution requirements. The fees, compared with other investment vehicles, are low, although this depends on the state administering the plan. Finally, everyone is eligible to take advantage of a 529 plan, and the amounts that can be put in are substantial (over $300,000 per beneficiary in many state plans). Generally, there are no income limitations or age restrictions.

A final rather unusual advantage of the assets in a 529 plan is that although they can be reclaimed by the donor (subject to income tax and the 10% additional penalty on any gains) the assets are not counted as part of the donor's gross estate for estate tax purposes. Thus 529 plans can be used as an estate planning tool to move assets outside of one's estate while still retaining some measure of control if the money is needed in the future. A beneficiary must be designated and the income tax savings are still only obtained if the money is eventually spent for education, though in some cases estate taxes can be reduced without spending the money on education. In addition, under the College Cost Reduction and Access Act of 2007, 529 college savings plans and prepaid tuition plans are now treated as an asset of the account owner (typically the parent), meaning they have little impact on a student's eligibility for financial aid.

Another benefit associated with 529 Plans is the ability to transfer unused amounts to other qualified members of the beneficiary's family without incurring any tax penalty. According to the IRS website (Publication 970), this type of transfer is known as a Rollover and is explained at length in their Qualified Tuition Program (QTP) section. Any amount paid to another QTP within 60 days of distribution is considered Rolled Over & does not require reporting anywhere on Form 1040 or 1040NR. Qualified members of the beneficiary's family include the beneficiary's: spouse; son, daughter, stepchild, foster child, adopted child, or a descendant of any of them; brother, sister, stepbrother, or stepsister; father or mother or ancestor of either; stepfather or stepmother; son or daughter of a brother or sister; brother or sister of father or mother; son-in-law, daughter-in-law, father-in-law, mother-in-law, brother-in-law, or sister-in-law; spouse of any individual listed above; and first cousin.

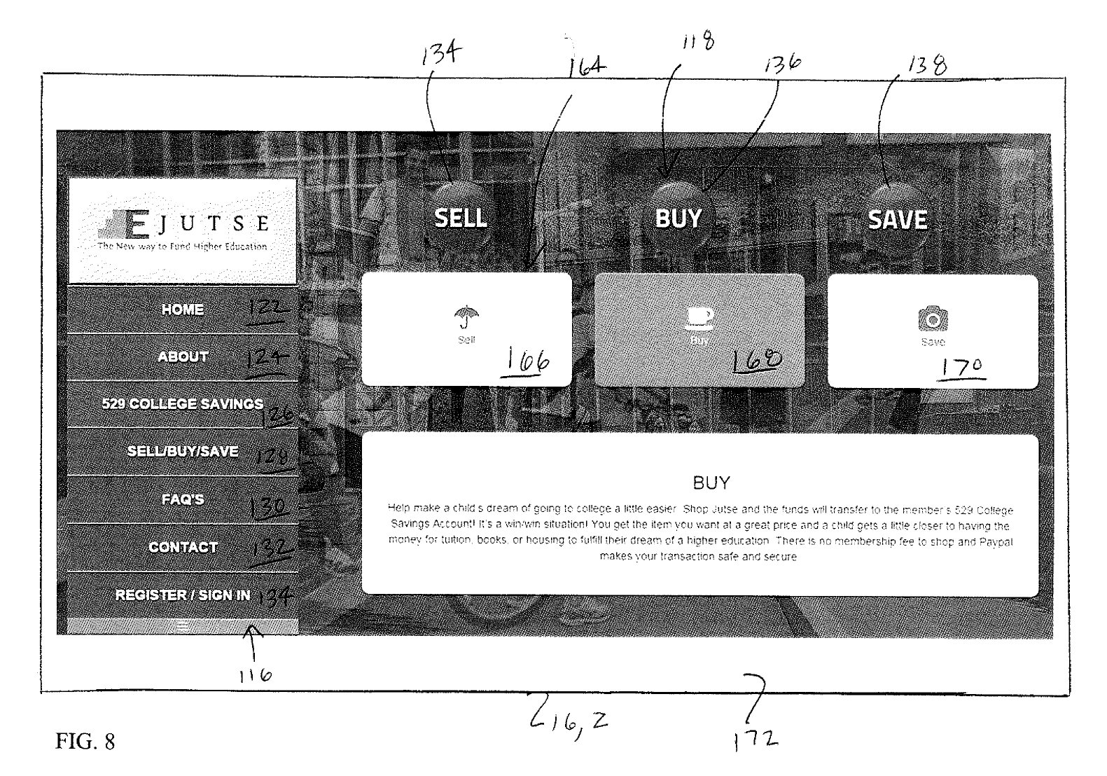

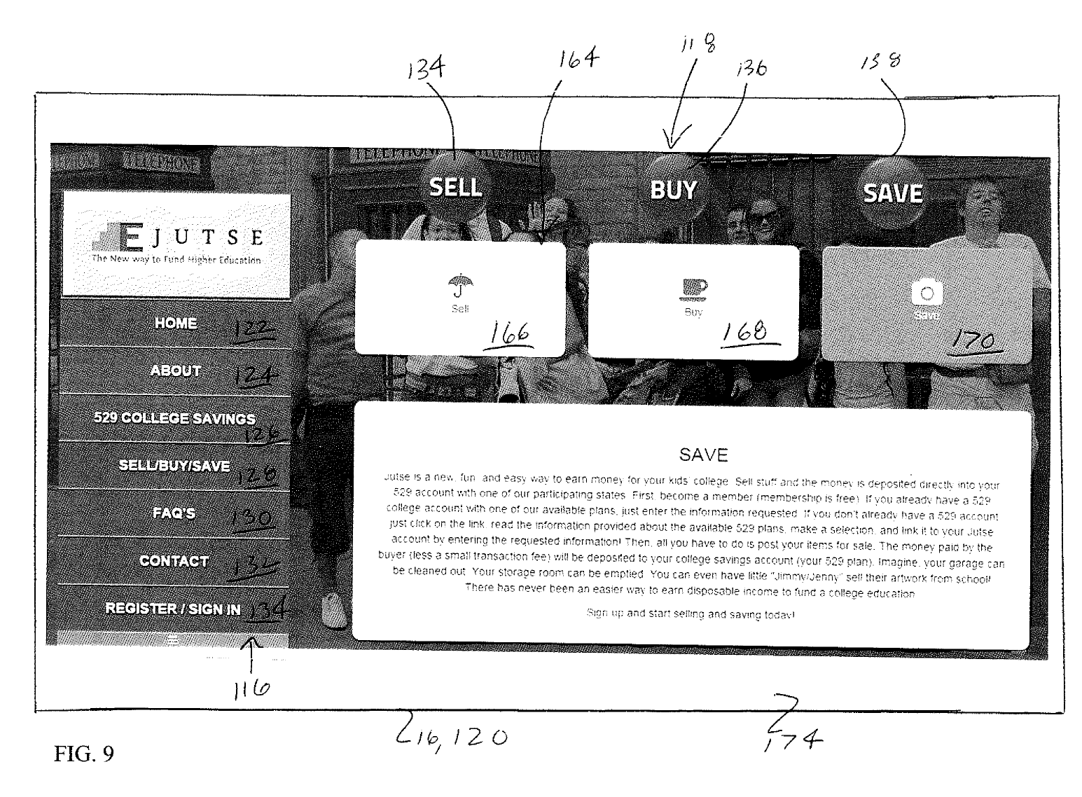

FIG. 7 illustrates a user's computer 16, 20 displaying an exemplary sell/buy/save page 144 that is reached by activating the “SELL/BUY/SAVE” link 126 described above. The illustrated sell/buy/save page 144 has the first plurality of links 116, the second plurality of links 118, and also has a fourth plurality of links or tabs (“SELL”, “BUY”, and “SAVE”) 164 that when selected by the user will take the user to other pages. The illustrated first or “SELL” link 166 takes the user to the sell/buy/save page 144 (see FIG. 7) as described in this paragraph so that the user has an additional way to the sell/buy/save page 144. The illustrated second or “BUY” link 168 takes the user to the buy page 172 (see FIG. 8) as described below. The illustrated third or “SAVE” link 170 takes the user to a save page 174 (see FIG. 9). In the illustrated embodiment, the fourth plurality of links 164 is displayed in a row at the top of the screen below the second plurality of links 188. Alternatively, the fourth plurality of links 164 can be located at any other suitable location. It is noted that the fourth plurality of links 164 can alternatively have any other suitable quantity and/or type of links. The illustrated sell/buy/save page 144 also displays introductory information about how to begin selling goods and/or services on the website. It is also noted that the sell/buy/save page 144 can alternatively have any other suitable form and/or information.

FIG. 8 illustrates a user's computer 16, 20 displaying an exemplary buy page 172 that is reached by activating the above-described “BUY” link 168. The illustrated buy page 172 has the first plurality of links 116, the second plurality of links 118, and the fourth plurality of links 164. The illustrated buy page 172 also displays introductory information about how to begin buying goods and/or services on the website. It is noted that the buy page 172 can alternatively have any other suitable form and/or information.

FIG. 9 illustrates a user's computer 16, 20 displaying an exemplary save information page 174 that is reached by activating the above-described “SAVE” link 170. The illustrated save page 174 has the first plurality of links 116, the second plurality of links 118, and the fourth plurality of links 164. The illustrated save page 174 also displays introductory information about how to save money for a 529 college savings plan using the website. It is noted that the save page 174 can alternatively have any other suitable form and/or information.

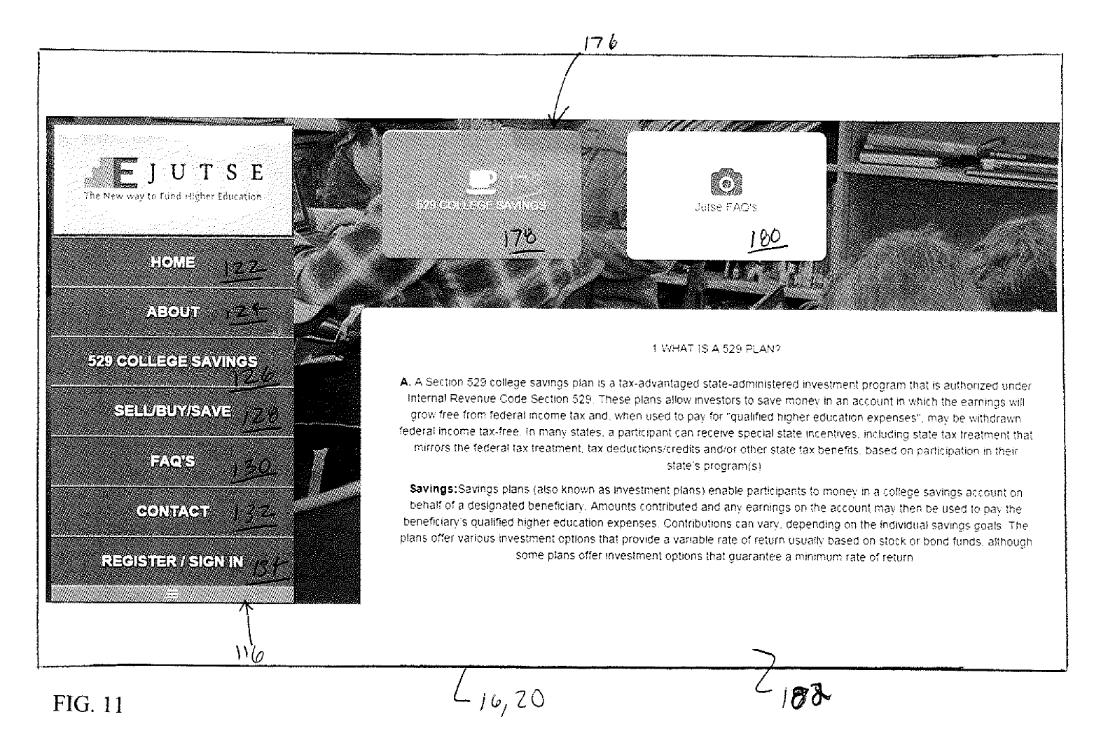

FIG. 10 illustrates a user's computer 16, 20 displaying an exemplary website frequently asked questions page 146 that is reached by activating the above-described “FAQ'S” link 128. The illustrated frequently asked questions page 146 has the first plurality of links 116 and also has a fifth plurality of links or tabs (“529 College Savings FAQ's”, and “website FAQ'S”) 176 that when selected by the user will take the user to other pages. The illustrated first or “529 College Savings FAQ's” link 178 takes the user to the 529 savings plan frequently asked questions page 182 (see FIG. 11) as described below. The illustrated second or “website FAQ'S” link 180 takes the user to the frequently asked questions page 146 (see FIG. 10) as described in this paragraph so that the user has an additional way to the frequently asked questions page. In the illustrated embodiment, the fifth plurality of links 176 is displayed in a row at the top of the screen. Alternatively, the fifth plurality of links 176 can be located at any other suitable location. It is noted that the fifth plurality of links 176 can alternatively have any other suitable quantity and/or type of links. The illustrated frequently asked questions page 146 also displays frequently asked questions about the website and answers to those questions. It is noted that the website frequently asked questions page 146 can alternatively have any other suitable form and/or information.

FIG. 11 illustrates a user's computer displaying an exemplary 529 savings plan frequently asked questions page 182 that is reached by activating the above-described “529 College Savings FAQ's” link 178. The illustrated 529 savings plan frequently asked questions page 182 has the first plurality of links 116 and the fifth plurality of links 176. The illustrated 529 savings plan frequently asked questions page 182 also displays frequently asked questions about 529 college savings plans and answers to those questions. It is noted that the 529 savings plan frequently asked questions page 182 can alternatively have any other suitable form and/or information.

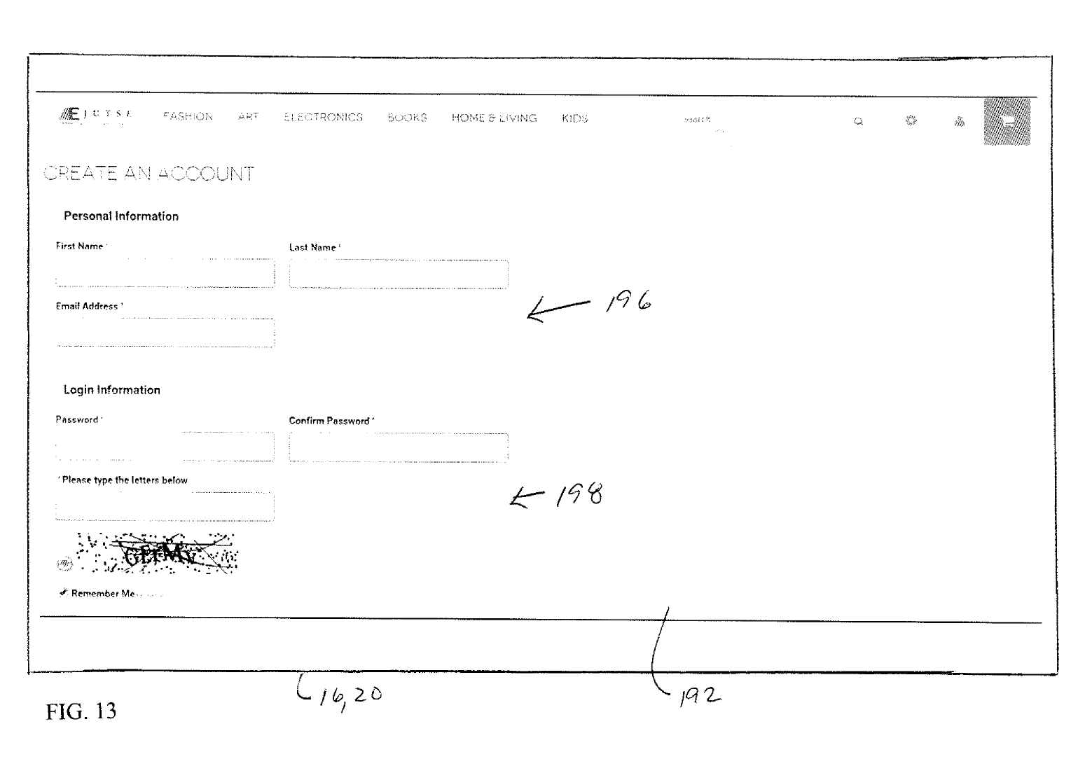

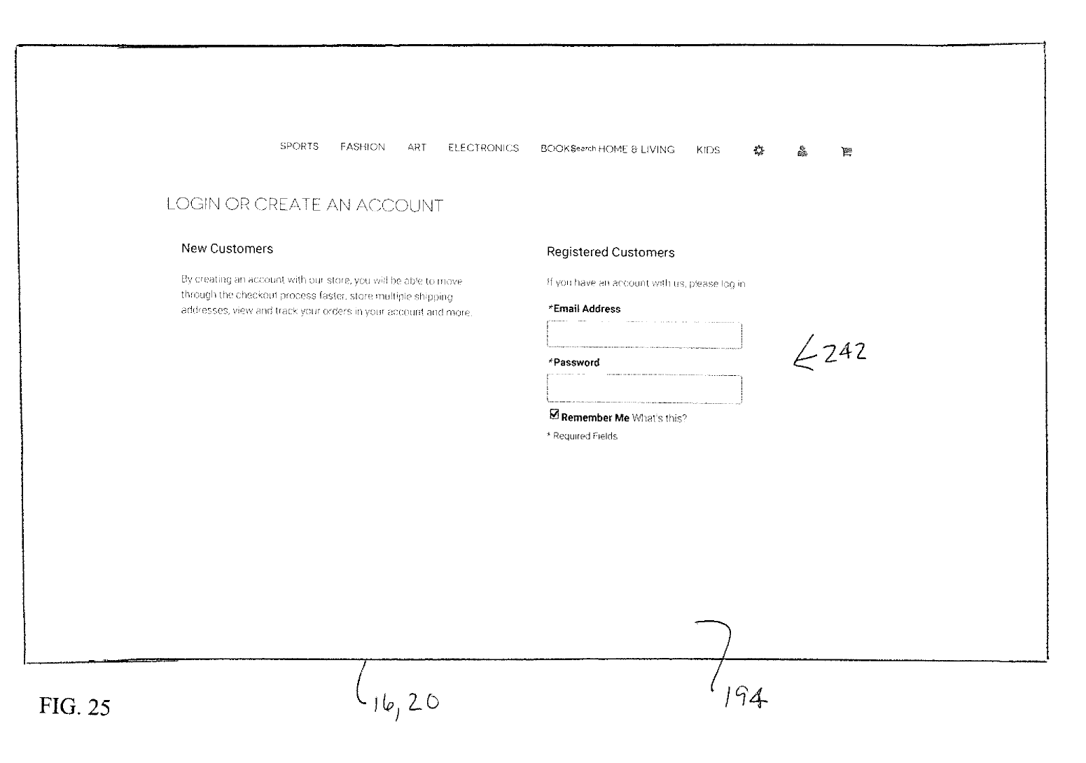

FIG. 12 illustrates a user's computer 16, 20 displaying an exemplary sell page or window 150 that is reached by activating the above-described “SELL” link 134. The illustrated sell page 150 has sixth plurality of links or buttons (“Register Now”, “Already a Member”, and “Learn more about 529 plans”) 184. The illustrated first or “Register Now” link 186 takes the user to a registration page (see FIG. 13) 192. The illustrated second or “already a Member” link 188 takes the user to a log-in page 194 (FIG. 25) that has data fields for a registered member to log in. The illustrated third or “Learn more about 529 plan” 190 link takes the user to a page of separate website providing information comparing 529 savings plans by state and other information such as, for example, www.collegesavings.org/planComparisonState.aspx. It is noted that the sell page 150 can alternatively have any other suitable form and or information.

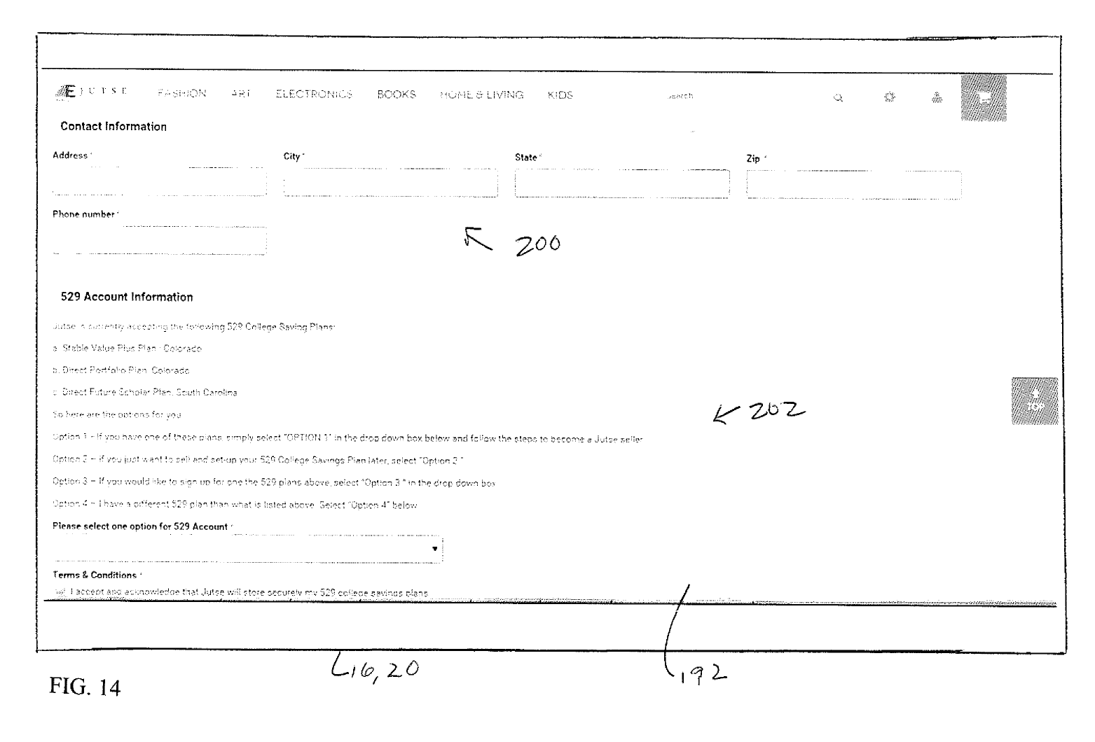

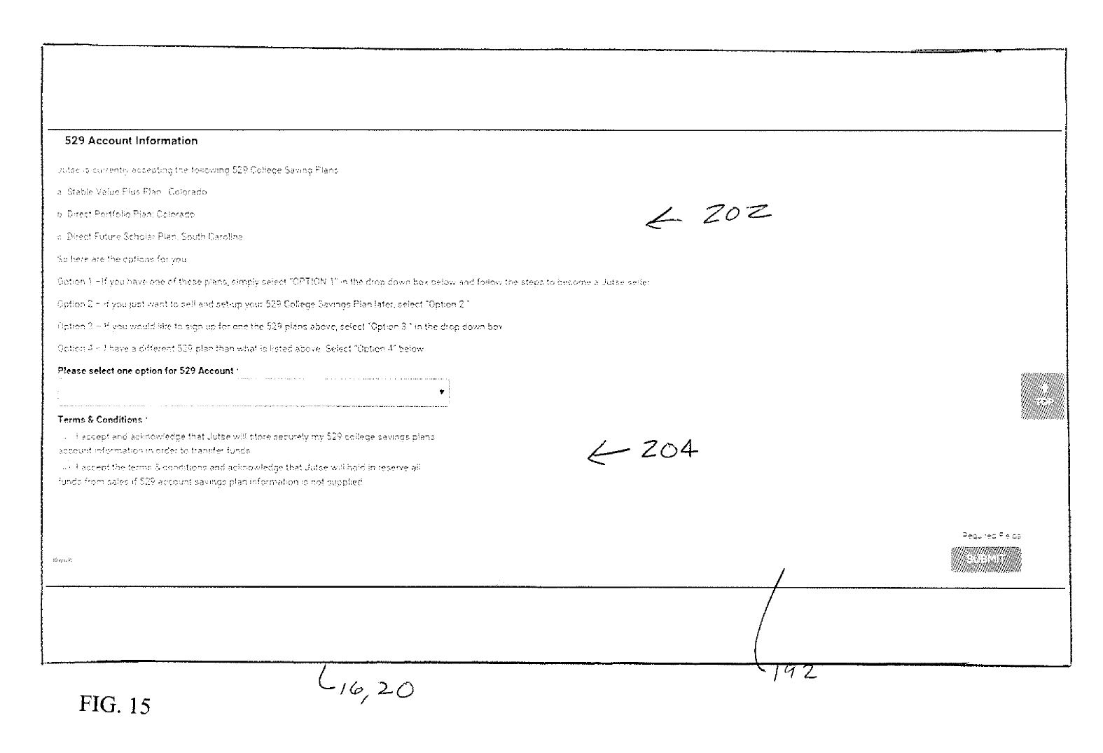

FIGS. 13 to 15 illustrate a user's computer 16, 20 displaying an exemplary registration page 192 that is reached by activating the above-described “Register Now link” 186. The illustrated registration page 192 provides personal information fields 196, login information fields 198, contact or address information fields 200, and 529 account information fields 202 each for entry of information by the user. The illustrated personal information fields 196 include a first name field, a last name field, and an email address field. The illustrated Login information fields 198 include a password field, a confirm password field and a security field in which the user must type letters illustrated below. The illustrated contact or address information fields 200 include an address field, a city field, a date field, a zip code field, and a phone number field. The illustrated 529 account information field 202 includes a pull down menu wherein the user can select one of a plurality of options for providing 529 account information as described in more detail hereinbelow. It is noted that there can alternatively be any other suitable quantity and/or type of data entry fields 196, 198, 200, 202. The illustrated registration page 192 also includes terms & conditions acknowledgement fields 204 wherein the user must acknowledge that the auction host will securely store the user's 529 savings account information in order to transfer funds from sales and that the action host 14 will hold in reserve all funds from sales prior to proper 529 savings account information being provided. It is noted that there can alternatively be any other suitable quantity and/or type of terms & condition fields 204. It is also noted that the registration page 192 can alternatively have any other suitable form.

The illustrated registration page 192 displays a list of the 529 college savings plans accepted by the website adjacent the 529 account information field. The illustrated pull down menu permits the user to select one of four options for providing 529 college savings plan account information. Illustrated option 1 is to select one of the currently accepted plans from the list of the 529 college savings plans if you currently have an account with one of the listed plans. Illustrated option 2 is to begin selling goods or services now and set up a 529 college savings plan account at a later time. Illustrated option 3 is to open an account with one of the currently accepted plans from the list of the 529 college savings plans. Illustrated option 4 is that the user has an account with a 529 college savings plan not on the list of currently accepted plans. It is noted that there can alternatively be any other suitable quantity and/or type of options.

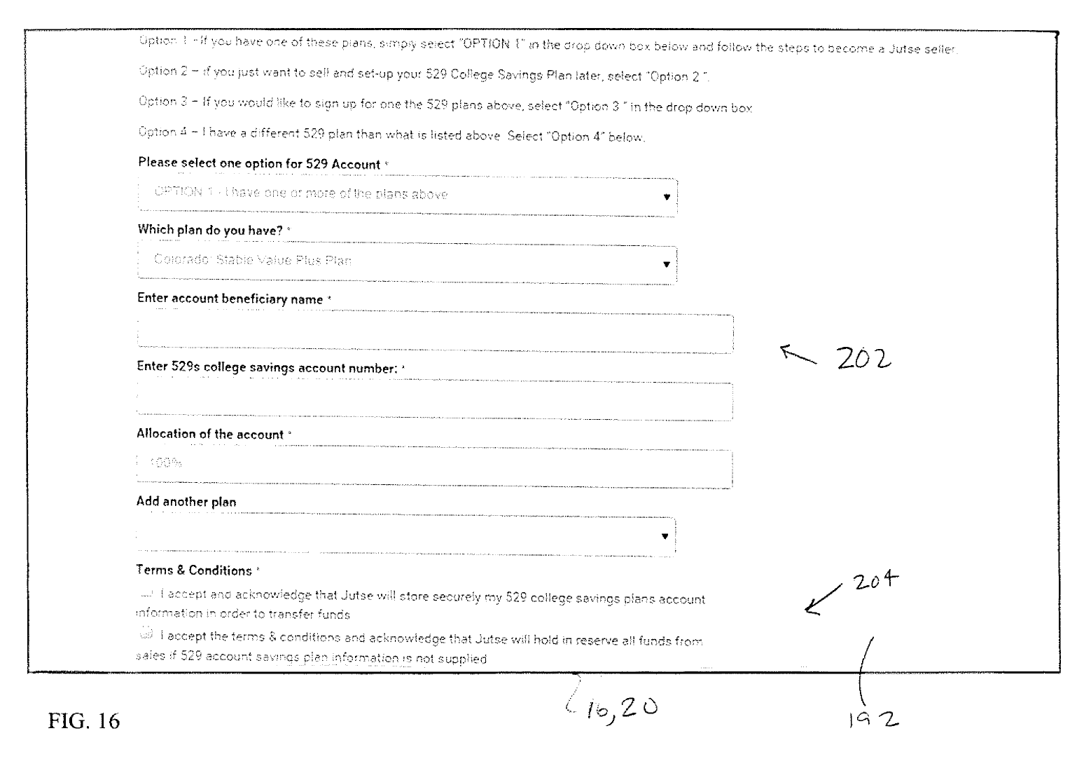

FIG. 16 illustrates the registration page 192 with option 1 selected by the user. When the user selects option 1 from the pull down menu, additional data entry fields are automatically displayed. The illustrated registration page 192 displays a pull down menu for selecting the 529 college savings plan, account beneficiary name field, an account number field, an allocation of the account (by percentage of sales), and an add another account field (which is available only if the previously entered accounts have been allocated less than 100% of sales). It is noted that there can alternatively be any other suitable quantity and/or type of additional fields.

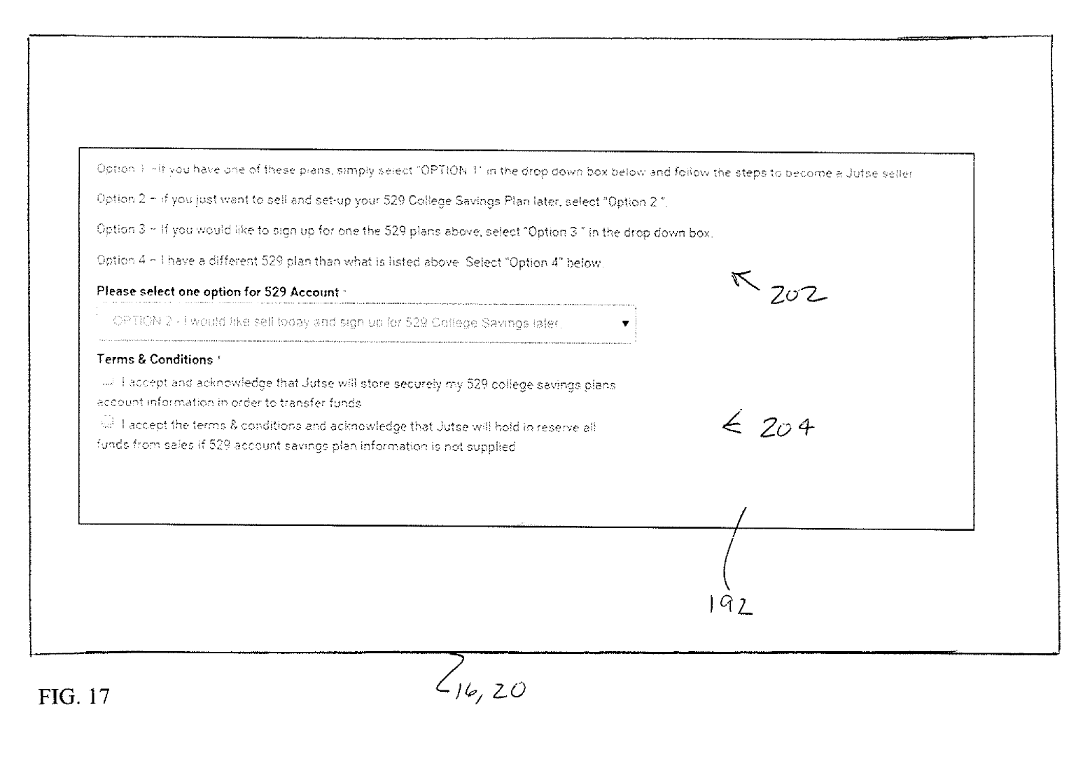

FIG. 17 illustrates the registration page 192 with option 2 selected by the user. When the user selects option 2 from the pull down menu, no additional data entry fields are displayed and the user is permitted to complete registration. The member is given a disclosure, and is required to acknowledge receipt of the disclosure, that funds from any sale remain in reserve or the trust or other separate account of the auction host, for them until they properly designate a savings plan account and provide the required identification information of the account. The illustrated auction host automatically sends reminder emails to the member that they need to designate a savings plan account.

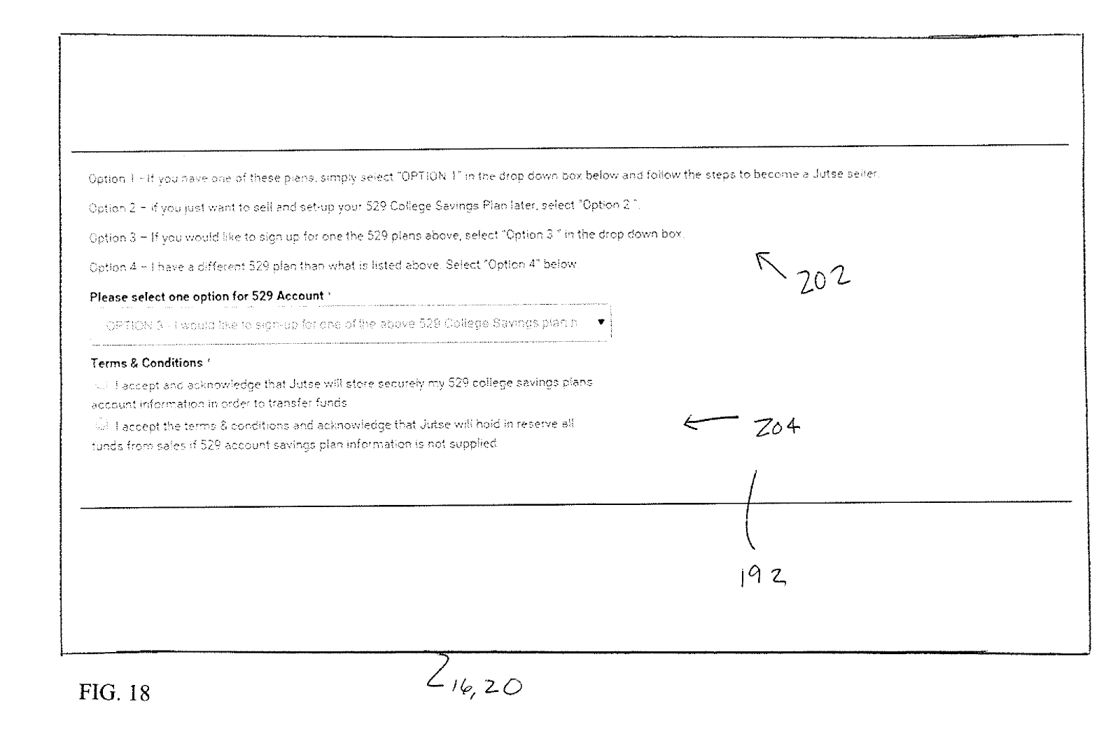

FIG. 18 illustrates the registration page 192 with option 3 selected by the user. When the user selects option 3 from the pull down menu, no additional data entry fields are displayed and the user is permitted to complete registration. The member is then directed to a page showing available plans and they click through to the enrollment page for the plan they want to select. The enrollment is done directly with the savings plans outside the auction host website. If the selected savings plan is one that currently works with the action host website, the member may immediately receive their savings plan account information and they can then enter that information into the registration page 192.

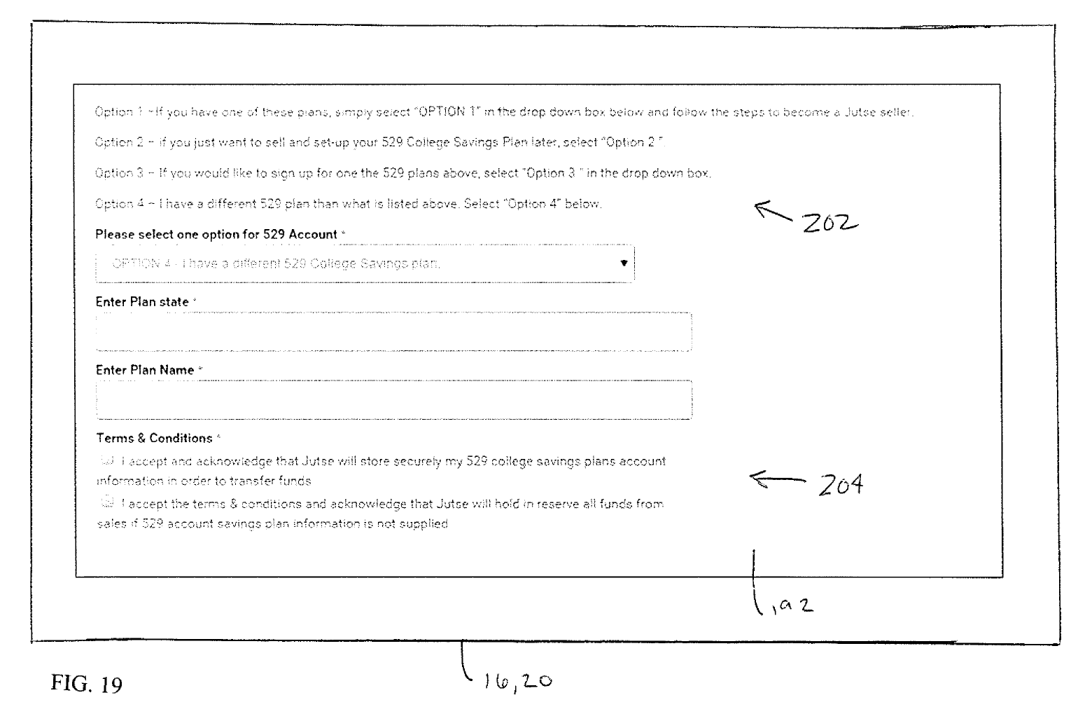

FIG. 19 illustrates the registration page 192 with option 4 selected by the user. When the user selects option 4 from the pull down menu, additional data entry fields are automatically displayed. The illustrated registration page 192 displays a plan state field and a plan name field. The member is given a disclosure, and is required to acknowledge receipt of the disclosure, that funds from any sale remain in reserve or the trust or other separate account of the auction host, for them until their designated begins to participate with the auction host website. The auction host then contacts the designated savings plan to get them to begin participating with the auction host website. It is noted that there can alternatively be any other suitable quantity and/or type of additional fields.

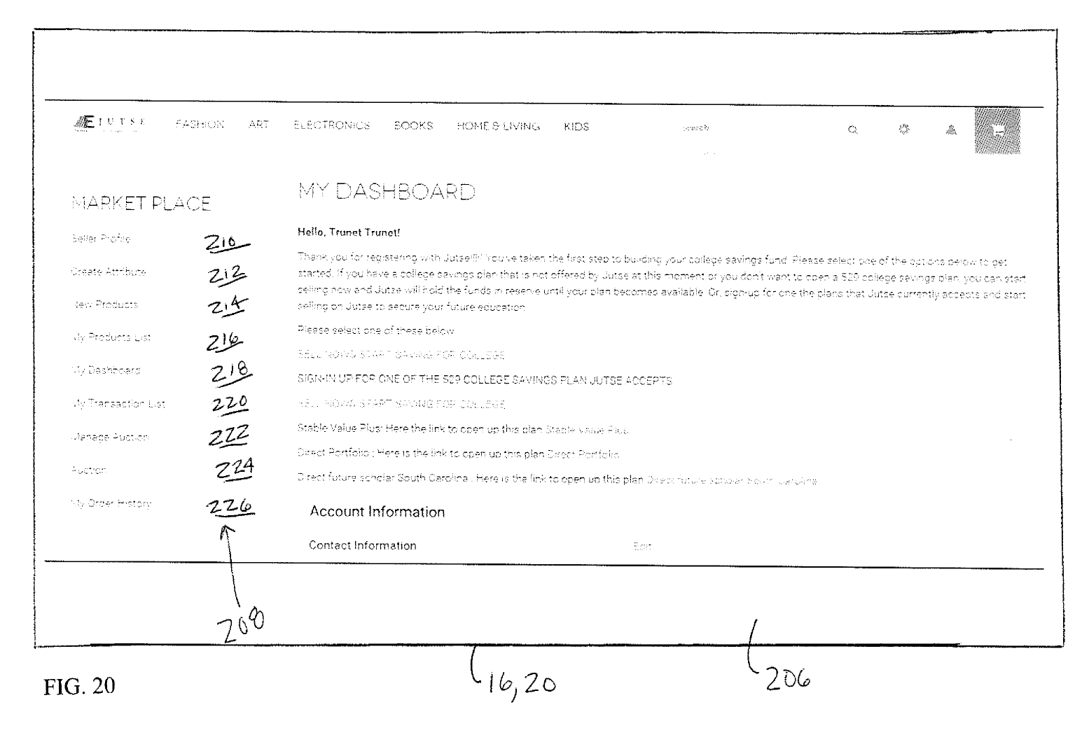

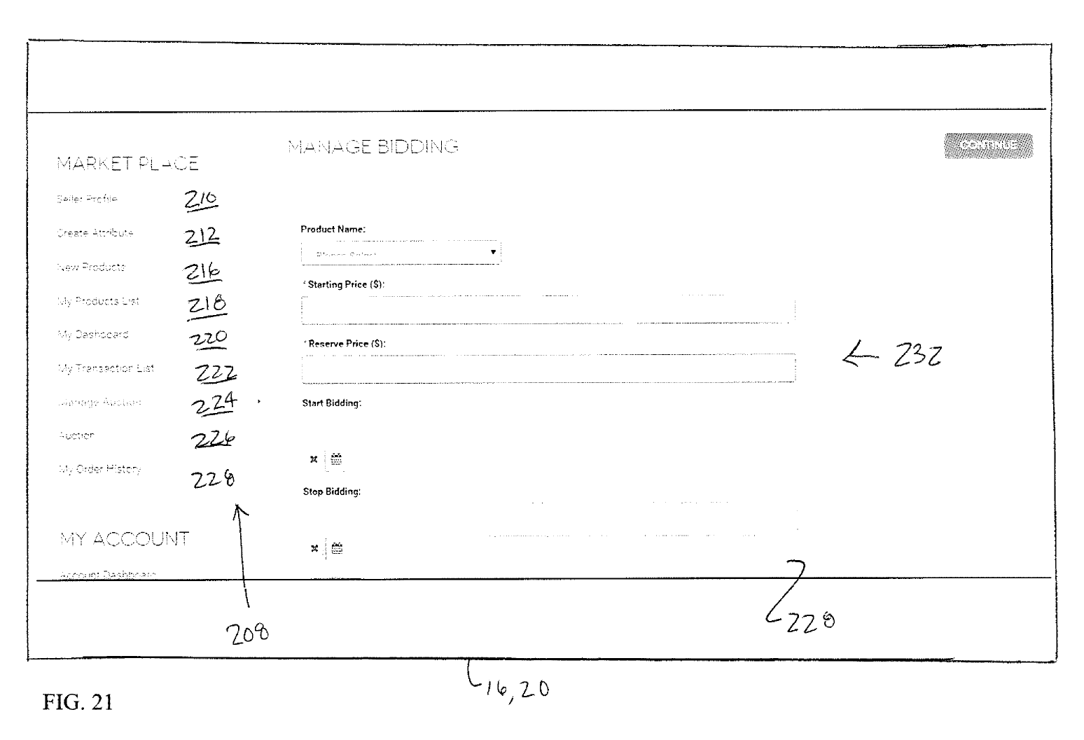

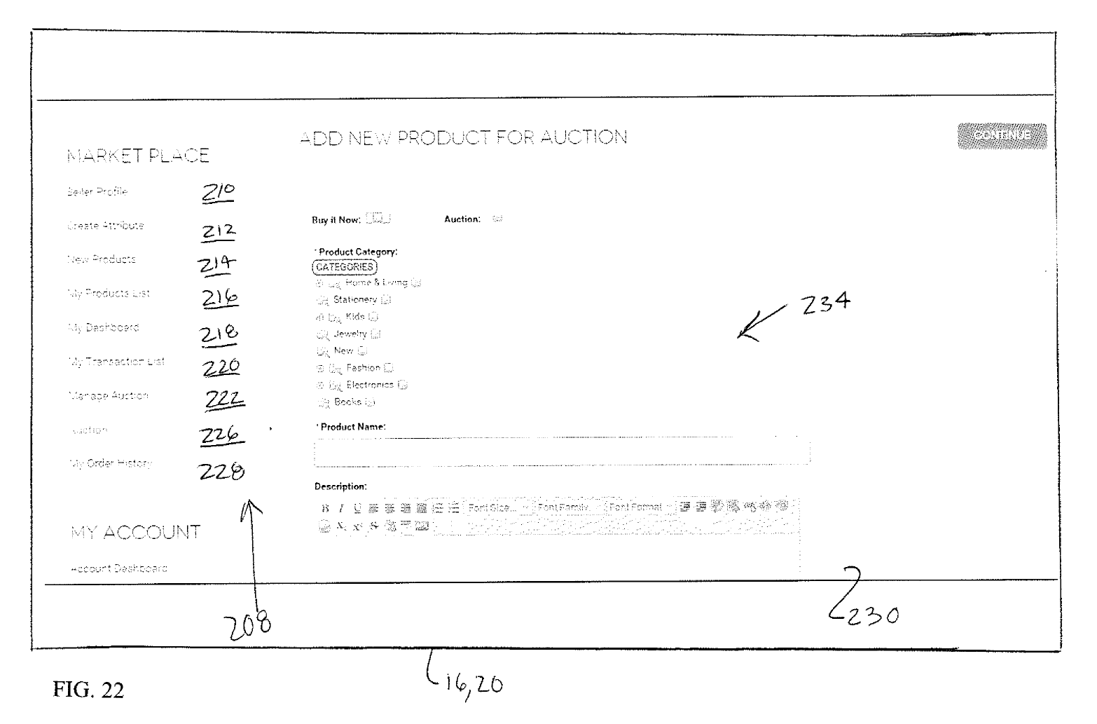

FIG. 20 illustrates a user's computer 16, 20 displaying an exemplary member dashboard page 206 that is reached by either logging into the site or activating a My Account link at the top of the screen when already logged into the site. The illustrated member dashboard page 192 enables the member to add new products or services for sale, manage sales, view products for sale, view transactions and order history, add or edit savings plan information, edit account information. The illustrated member dashboard page 192 displays a seventh plurality of links or buttons (“Seller Profile”, “Create Attribute”, “New Products”, “My Products List”, “My Dashboard”, “My Transaction List”, “Manage Auction”, “Auction”, and “My Order History”) 208. The illustrated first or “Seller Profile” link 210 takes the user to a seller profile page of the web platform wherein the user can create and/or edit a profile that will be displayed to potential buyers of the user's goods and/or services for sale. The illustrated second or “Create Attribute” link 212 takes the user to an attributes page of the web platform wherein the user can create and/or edit attributes. The illustrated third or “New Products” link 214 takes the user to a new products page of the web platform which has a list of new products or services for sale by the user. The illustrated fourth or “My Products List” link 216 takes the user to a member products page of the web platform that displays a list of goods and/or service for sale or sold by the member. The illustrated fifth or “My Dashboard” link 218 takes the user back to this member dashboard page 206 of the web platform (see FIG. 20). The sixth or “My Transaction List” link 220 takes the user to a transaction page of the web platform that displays a list of all of the member's prior sale transactions. The illustrated seventh or “Manage Auction” link 222 takes the user to a manage bidding page 228 of the web platform (FIG. 21). The illustrated eighth or “Auction” link 224 takes the user to an auction page 230 of the web platform (FIG. 22). The illustrated ninth or “My Order History” link 226 takes the user to an order history page of the web platform that displays a list of all of the member's prior purchases. In the illustrated embodiment, the seventh plurality of links 208 is displayed in a column at the left side of the screen. Alternatively, the seventh plurality of links 208 can be located at any other suitable location. It is noted that the seventh plurality of links 208 can alternatively have any other suitable quantity and/or type of links. It is noted that the member dashboard page 206 can alternatively have any other suitable form and/or information.

FIG. 21 illustrates a user's computer 16, 20 displaying an exemplary manage bidding page 228 that is reached by activating the above-described “Manage Auction Link”. The illustrated manage bidding page 228 provides of plurality of data entry fields 232 for entry of information by the member. The illustrated plurality of data entry fields 232 includes a product name pull down menu with which the member can select a product or service from a list of their products and services that are for sale, a starting price field, a reserve price field, a start bidding date/time, and a stop bidding date/time. It is noted that the data entry fields 232 can alternatively have any other suitable quantity and/or type of fields. It is also noted that the manage bidding page 228 can alternatively have any other suitable form and/or information.

FIG. 22 illustrates a user's computer 16, 20 displaying an exemplary auction page 230 that is reached by activating the above-described “auction” link. The illustrated auction page 230 provides of plurality of data entry fields 234 for entry of information by the member in order to add a new product or service for auction. The illustrated plurality of data entry fields 234 includes a buy it now switch with which the member can select to provide a buy it now price in addition to or instead of an auction, a plurality of product category fields with which the member can select the product categories that the new product should be included, a product name field with which the member can provide the name of the new product or service, and a description field with which the member can provide a written description of the new product or service. It is noted that the data entry fields 234 can alternatively have any other suitable quantity and/or type of fields. It is noted that the auction page 230 can alternatively have any other suitable form and/or information.

FIG. 23 illustrates a user's computer 16, 20 displaying an exemplary marketplace page 152 that is reached by activating the above described “BUY” link 136 or a market place link at the top of the display of most pages. The illustrated marketplace page 152 displays a plurality of goods and/or services for sale. Each illustrated individual product listing includes the name of the product or service the current price of the product or service, and a photo of the product or service (if available). The illustrated marketplace page 152 also includes an eighth plurality of links (“Fashion”, “Art”, “Electronics”, “Books”, “Home & Living”, and “Kids”) 236 for various product categories that when activated displays only goods and/or services of the selected product category. It is noted that the eighth plurality of links 236 can alternatively have any other suitable quantity and/or type of links and/or product categories. The illustrated marketplace page 152 also includes a search field 238 with which a user can perform a word search of products and/or services available for sale. It is noted that the marketplace page 152 can alternatively have any other suitable form and/or information.

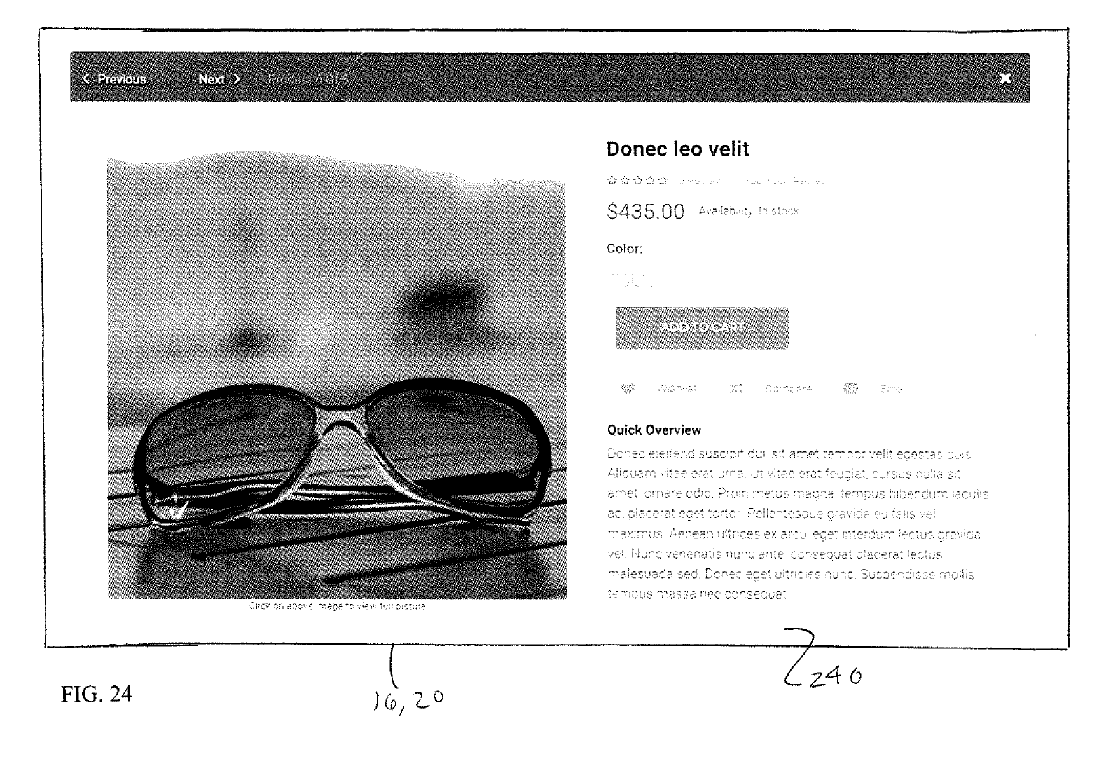

FIG. 24 illustrates a user's computer 16, 20 displaying an exemplary product detail page 240 that is reached by selecting an individual product listing on the marketplace page 152. The illustrated product detail page 240 includes a photograph of the good or service, the name of the good or service, a customer rating with links to view an add reviews, the current price of the good or service, the availability of the good or service, feature selections (such as color, size, etc.), a link to add the good or service to the user's cart, links to add to wish list, compare with other products or service, and email a description, and a description of the product or service. It is noted that the product detail page 240 can alternatively have any other suitable form and/or information.

FIG. 25 illustrates a user's computer 16, 20 displaying an exemplary login page 194 that is reached by selecting the “Already a Member” link 188 on the sell page (see FIG. 12) or the login link at the top of most pages. The illustrated login page 194 provides data entry fields 242 for a registered user or member to log into the site. The illustrated login page 194 includes data fields 242 for the user to input their email address and password. It is noted that the login page 194 can alternatively have any other suitable form and/or information.

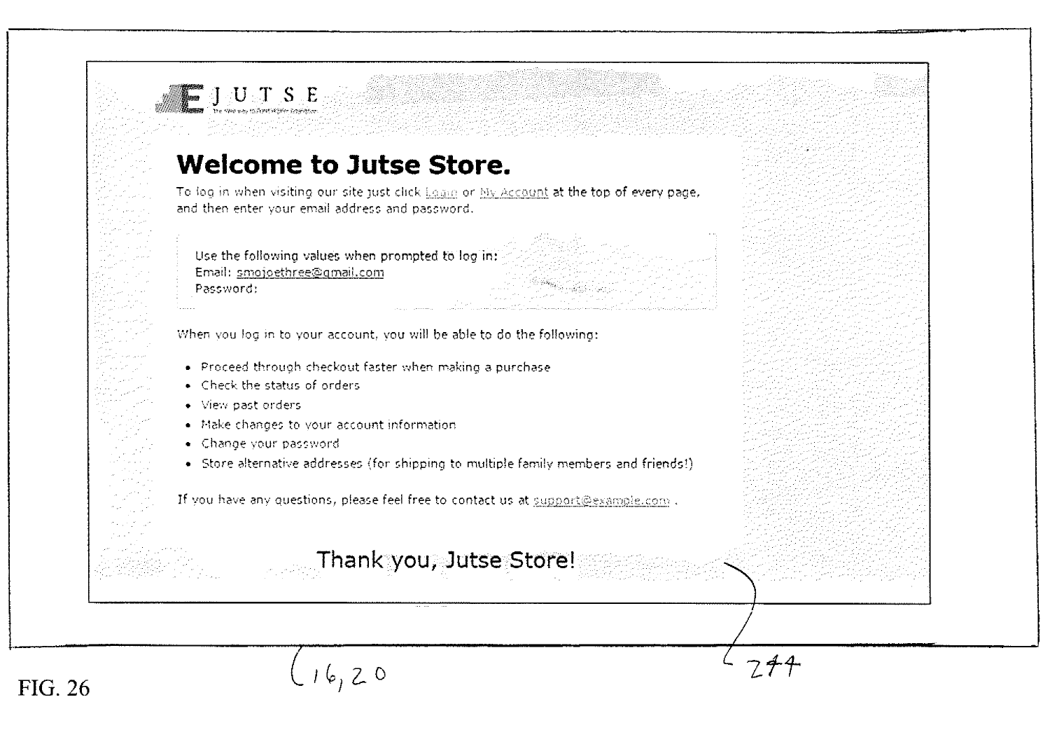

FIG. 26 illustrates a user's computer 16, 20 displaying an exemplary sign-up email 244 that is sent to a user's email address upon completing registration. The illustrated sign-up email 244 provides instructions to login to the site and the actions that can be taken by the member once logged into the site. It is noted that the sign-up email 244 can alternatively have any other suitable form and/or information.

Any of the features or attributes of the above described embodiments and variations can be used in any combination with any of the other features and attributes of the above described embodiments and variations as desired.

From the forgoing disclosure and detailed description, it is apparent that the system and methods for an hosted online site for selling goods and/or services according to the present invention enable sale proceeds to be more easily generated and saved for higher education savings plans and the like which is becoming increasingly important with the rapidly increasing costs of higher education.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention.

What is claimed is:

1. A computer implemented method for facilitating online sale of goods and/or services, said method comprising the steps of, in combination:
electronically presenting at least one good and/or service available for purchase from a seller;
electronically receiving at least one designation from the seller of a savings plan account to receive at least a portion of proceeds from sale of the at least one good and/or service available for purchase from the seller;
electronically receiving a purchase fee from a buyer for purchasing the at least one good and/or service available for purchase from a seller;
electronically receiving a transaction fee, separate from the purchase fee, from the buyer for purchasing the good and/or service available for purchase from a seller; and
directly providing the purchase fee to the at least one savings plan account designated by the seller on behalf of the seller.

2. The computer implemented method of claim 1, further comprising the step of depositing the transaction fee and the purchase fee in separate accounts.

3. The computer implemented method of claim 1, further comprising the step of retaining the transaction fee as compensation from the seller.

4. The computer implemented method of claim 1, wherein savings plan account is a 529 college savings plan account.

5. The computer implemented method of claim 1, further comprising the step of electronically displaying to the seller at least one savings plan provider available for designating the savings plan account.

6. The computer implemented method of claim 1, wherein the purchase fee is retained until the at least on designation is received from the seller if the purchase fee is received prior to receiving the at least one designation.

7. The computer implemented method of claim 1, further comprising the step of electronically displaying to the seller at least one link to a savings plan provider website for enrolling in a savings plan.

8. A system for online sale of goods and/or services, said system comprising, in combination:
at least one central computer having memory, a processor in communication with the memory, and a network interface in communication with the processor for communicating with electronic devices; and
wherein the memory comprising computer-executable instructions executable by the processor to perform the following steps:
electronically presenting at least one good and/or service available for purchase from a seller;
electronically receiving at least one designation from the seller of a savings plan account to receive at least a portion of proceeds from sale of the at least one good and/or service available for purchase from the seller;
electronically receiving a purchase fee from a buyer for purchasing the at least one good and/or service available for purchase from a seller;
electronically receiving a transaction fee, separate from the purchase fee, from the buyer for purchasing the good and/or service available for purchase from a seller; and
directly providing the purchase fee to the at least one savings plan account designated by the seller on behalf of the seller.

9. The system of claim 8, further comprising the step of depositing the transaction fee and the purchase fee in separate accounts.

10. The system of claim 8, further comprising the step of retaining the transaction fee as compensation from the seller.

11. The system of claim 8, wherein savings plan account is a 529 college savings plan account.

12. The system of claim 8, further comprising the step of electronically displaying to the seller at least one savings plan provider available for designation of the saving plan account.

13. The system of claim 8, wherein the purchase fee is retained until the at least on designation is received from the seller if the purchase fee is received prior to receiving the at least one designation.

14. The system of claim 8, further comprising the step of electronically displaying to the seller at least one link to a savings plan provider website for enrolling in a savings plan.

15. One or more computer-readable media storing instructions for facilitating online sale of goods and/or services comprising computer-executable instructions that responsive to execution cause operations to be performed comprising, in combination:
electronically presenting at least one good and/or service available for purchase from a seller;
electronically receiving at least one designation from the seller of a savings plan account to receive at least a portion of proceeds from sale of the at least one good and/or service available for purchase from the seller;
electronically receiving a purchase fee from a buyer for purchasing the at least one good and/or service available for purchase from a seller;
electronically receiving a transaction fee, separate from the purchase fee, from the buyer for purchasing the good and/or service available for purchase from a seller; and
directly providing the purchase fee to the at least one savings plan account on behalf of the seller.

16. The computer-readable media of claim 15, further comprising the step of depositing the transaction fee and the purchase fee in separate accounts.

17. The computer-readable media of claim 15, further comprising the step of retaining the transaction fee as compensation from the seller.

18. The computer-readable media of claim 15, wherein savings plan account is a 529 college savings plan account.

19. The computer-readable media of claim 15, further comprising the step of electronically displaying to the seller at least one savings plan provider available for designation of the savings plan account.

20. The computer-readable media of claim 15, wherein the purchase fee is retained until the at least on designation is received from the seller if the purchase fee is received prior to receiving the at least one designation.
